(19) United States
(12) Patent Application Publication
(10) Pub. No.: US 2001/0013004 A1
(43) Pub. Date: Aug. 9, 2001

(54) Brand resource management system

(76) Inventors: Jordan Haris, White Plains, NY (US); Marco Loretto, New York, NY (US)

Correspondence Address: Brain S. Rosenbloom, MINTZ LEVIN COHN FERRIS GLOVSKY AND POPEO P.C., Suite 400, 11911 Freedom Drive, Reston, VA, 20190, US

(21) Appl. No.: 09/727,121

(22) Filed: Nov. 30, 2000

Related U.S. Application Data
(63) Continuation-in-part of application No. 09/185,485, filed on Nov. 3, 1998.

(51) Int. Cl. G06F 17/60

(52) U.S. Cl. 705/1

(57) ABSTRACT

A brand resource management system that enables a brand owner and its licensing partner, sponsorship and media partners (“partners”) to work faster and more cohesively by streamlining business processes and information flows; accelerate the development and approval of new products and campaigns; make smarter decisions through deeper understanding of business performance; and partner more effectively with key retailers. The brand resource management system is a secure, partner/server, Internet-based, system that automates all aspects of a brand resource management, and in so doing, minimizes costs and maximizes revenues. The system is used by brand owners and their partners. It provides fast, effective, and secure mechanisms for: reporting sales data and royalties, analyzing and reporting on collected sales data, managing the product development process, from concept submission, through review and modification, and on to final approval, and creating and communicating contract terms between owners and partners. In one embodiment, BRMS includes a server application that includes a number of modules, each providing a core set of tasks. These modules include: a Central Administration module, a Sales Reporting module, a Budgeting and Forecast module, a Sales Analysis, an Approvals module, a Contract Management module, and a Digital Style Guide module.

This application is a continuation-in-part of U.S. patent application Ser. No. 09/185,485, filed Nov. 3, 1998, the entire contents of which are incorporated herein by this reference.

### BACKGROUND OF THE INVENTION

1. Field of the Invention

The present invention is generally related to brand resource management, and, more specifically, to a system for improving and enhancing collaboration between brand owners and their partners.

2. Discussion of the Background

Consumer brand companies, such as Levis, Nike, Gatorade, and others, face a number of obstacles in implementing their brand strategies and programs. For example, time-to-market is slow because approval processes (e.g., product approvals) are inefficient; more time is spent on workflow and administrative tasks and less time finding new opportunities; and problems exist with the accuracy and timeliness with respect to the reporting of performance data from licensees, sponsors, and other partners of the brand owner.

What is desired, therefore, is a system and/or method that overcomes these and other disadvantages associated with brand resource management.

### SUMMARY OF THE INVENTION

The present invention provides a brand resource management system (referred to as “BRMS”) that overcomes many of the above described problems associated with brand resource management. The brand resource management system enables a brand owner (“owner”) and its licensing, sponsorship and media partners (“partners”) to: (1) work faster and more cohesively by streamlining business processes and information flows; (2) accelerate the development and approval of new products, advertising campaigns, promotions, artwork, etc; (3) make smarter decisions through deeper understanding of business performance; and (4) partner more effectively with key retailers.

The brand resource management system is a secure, Internet-based system that automates all aspects of a brand resource management, and in so doing, minimizes costs and maximizes revenues. The system is used by brand owners and their partners. It provides fast, effective, and secure mechanisms for: reporting sales data and royalties, analyzing and reporting on collected sales data, managing the product approval process, from concept submission, through review and modification, and on to final approval, and creating and communicating contract terms between owners and partners.

In one embodiment, BRMS includes a server application that includes a number of modules, each providing a core set of tasks. These modules include: a Central Administration module, a Sales Reporting module, a Budgeting and Forecast module, a Sales Analysis module, an Approvals module, a Contract Management module, and a Digital Style Guide module. Some of the modules are used exclusively by a brand owner and some are used by both an owner and a partner.

The Central Administration module includes tasks that enable an owner to set up and maintain the BRMS server application. The Sales Reporting module enables the partner to submit sales data, and it enables both owner and partner to create and edit sales accounts, and to generate reports on both accounts and sales figures. The Sales Analysis module enables owners to review and analyze the sales data reported by partners.

The Budgeting & Forecast (“BF”) module provides a brand owner with a collaborative, online forum for creating, and monitoring royalty budgets, and forecasts. The BF module includes sub-modules that make it easy to set up and maintain budgets, monitor performance, run comparison reports, and populate new budgets.

The Approvals module makes submission, review, feedback, and approval of product designs, advertising campaigns, promotions, artwork, etc., from partner and third-parties to owners, a simple, fully automated, and almost instantaneous process. Using the power and presence of the Internet, the Approvals module connects everyone in the partner, third party, and owner organization in an immediate, graphical communications channel.

The Contract Management module provides a mechanism for creating, editing, and viewing contract term sheets, and also for generating and reviewing detailed reports on selected contracts. Contracts form the basis of the owner-partner business relationship. The contract identifies the products, territories, distribution channels, and other business items that govern the business relationship, and it also specifies detailed business thresholds and sales royalty data.

The Digital Style Guide (“DSG”) module is used by owners and partners to trade property style assets, and related information, via a secure Internet connection. This module facilitates the management and control of assets such as trademarks, logos, fonts, dimensions, color schemes, distribution, packaging, store display, and related information pertaining to brand owner property. The DSG module eliminates the cost, delays, and errors associated with traditional paper and CD-ROM style guide distribution methods. Digital style guides are available twenty four hours a day, seven days a week, for online review and download.

Further features and advantages of the present invention, as well as the structure and operation of various embodiments of the present invention, are described in detail below with reference to the accompanying drawings.

### BRIEF DESCRIPTION OF THE DRAWINGS

The accompanying drawings, which are incorporated herein and form part of the specification, illustrate various embodiments of the present invention and, together with the description, further serve to explain the principles of the invention and to enable a person skilled in the pertinent art to make and use the invention. In the drawings, like reference numbers indicate identical or functionally similar elements. Additionally, the left-most digit(s) of a reference number identifies the drawing in which the reference number first appears.

FIG. 1 depicts a brand resource management system (BRMS) 110 in accordance with one embodiment of the present invention.

FIG. 2 depicts a functional block diagram of the brand resource management server according to one embodiment.

FIG. 3 is a flowchart illustrating an exemplary work flow.

FIGS. 4-60 illustrates exemplary user interface of the brand resource management system.

### DETAILED DESCRIPTION OF THE PREFERRED EMBODIMENTS

Embodiments of brand resource management systems and methods of the present invention, as described below, use the Internet to provide connectivity between brand owners and partners of the brand owners, thereby providing increased efficiency to the brand resource management process. However, embodiments of the present invention are not limited to systems and methods using the Internet, but rather, include systems and methods that utilize other computer networking schemes.

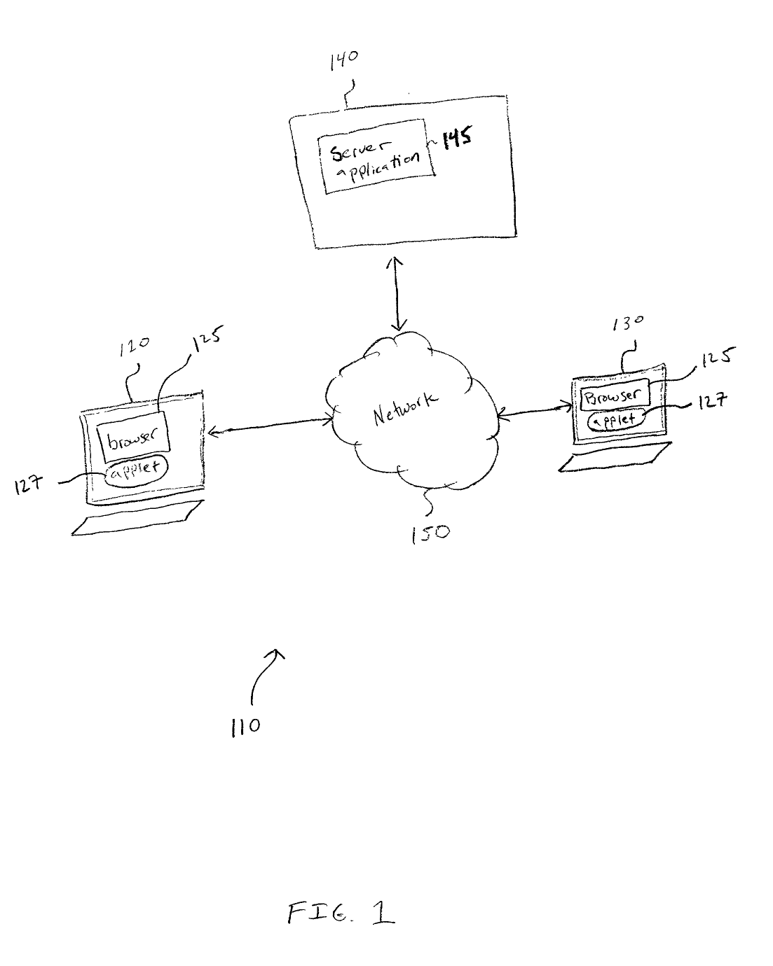

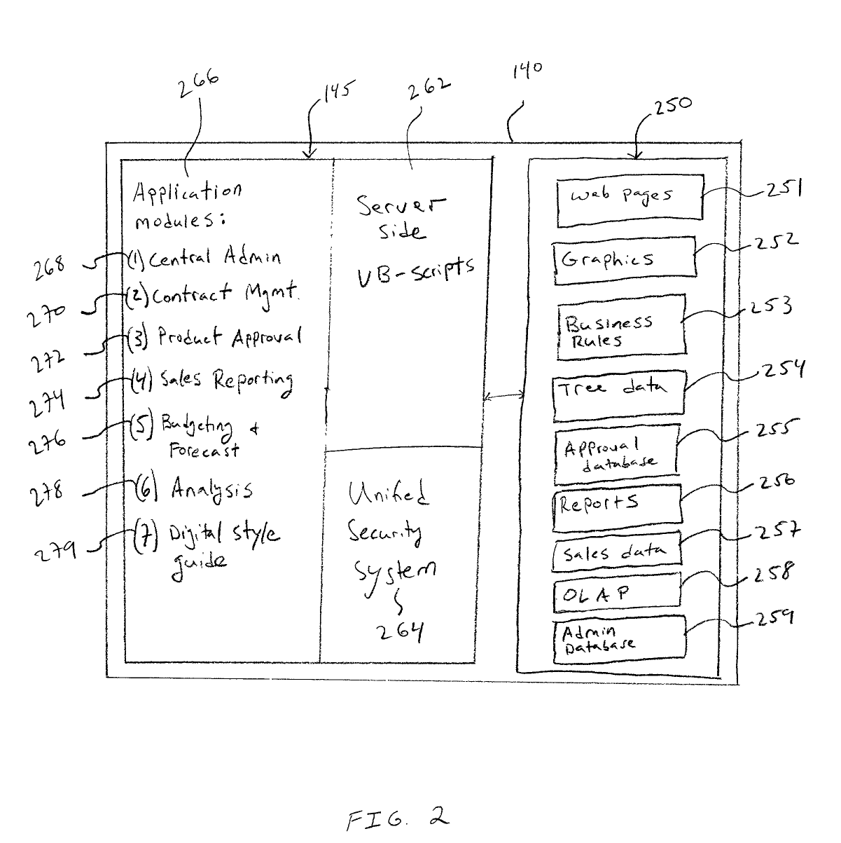

FIG. 1 depicts a brand resource management system (BRMS) 110 in accordance with one embodiment of the present invention. BRMS 110 includes an owner workstation 120, a partner workstation 130, a brand resource management server 140 and a network 150. The brand resource management server 140 executes a brand resource management server application 145. Preferably, both the owner workstation 120 and partner workstation 130 execute a web browser 125 and applet(s) 127. Preferably, web browser 125 is a Java compatible browser and applet(s) 127 are Java applets. An owner or partner uses his or her web browser 125 to access the brand resource management server application 145.

The owner workstation 120 and the partner workstation 130 are coupled to the brand resource management server 140 through the network 150. In one embodiment, the network 150 may include the Internet, and the owner workstation 120 and the partner workstation 130 may be at remote sites from the brand resource management server 140. In other embodiments, one, or both, of the owner workstation 120 and the partner workstation 130 may be co-located with the brand resource management server 140 and directly coupled to the brand resource management server rather than over a network as shown in FIG. 1.

The brand resource management server 140 may be implemented using a Windows NT® server that includes the following hardware: an Intel® Pentium Processor (or comparable processor); 128 Mbytes of random access memory (RAM); and 18 Gbytes of free disk space for storing a database system. The Windows NT® server includes the following software: Microsoft Windows NT® Server Version 4.0; and Microsoft Internet Information Server (IIS) Version 4.0 or higher. Preferably, the brand resource management server 140 includes a high speed connection to the network 150.

In addition, in embodiments of the invention, multiple owner workstations 120 and partner workstations 130 may be coupled to the network 150 to allow a plurality of partners of an owner to access the brand resource management server 140 or to allow a plurality of employees or agents of the owner or partner(s) to access the brand resource management server 140.

FIG. 2 depicts a functional block diagram of the brand resource management server 140 in accordance with one embodiment of the present invention. It is an implementation of the common “n-tier architecture model” that uses a distributed internet application to generate web pages created by custom-built Microsoft ActiveX components on a dedicated Web server and return information to dynamically construct HTML pages. The brand resource management server 140 includes a database system 250 and, as mentioned above, a server application 145. The database system 250 functions as the primary database system of the brand resource management system 110, and in one embodiment, as shown in FIG. 2, contains web pages 251, graphics 252, business rules 253 related to the operational and licensing strategies of a brand owner, a tree data database, an approval database, reports, a sales data database, one or more on-line analytical processing (OLAP) databases, and an admin database. In a preferred embodiment, many of the databases are implemented using a Microsoft SQL Server™ database.

In other embodiments of the present invention, functions of the brand resource management server 140 may be shared by a number of networked computers. For example, one of the networked computers can provide the web server functions of the brand resource management server 140; one computer can provide the database functions of the brand resource management server 140, and one computer can provide the application modules functions.

The server application 145 includes three functional sections including server-side VBScript 262, application modules 266, and a unified security system 264. The server-side VB script 262 contains instructions for implementing high-level finctions performed by the brand resource management systems, and in one embodiment, these instructions are written primarily in Microsoft Visual Basic and Visual C++, and include components consisting of HTML dynamic JAVA elements, and Perl code and Perl script.

The unified security system is used to implement security features to limit access to the system to authorized users. The unified security system operates in conjunction with the central administration module (described below) to implement the security features. In one embodiment, the unified security system includes Microsoft's Certificate Server which is used in conjunction with the brand resource management modules and Windows NT Security/ADSI to issue digital certificates to authorized users' workstations. The digital certificates enable communication between a owner or a partner with the brand resource management server in a secure manner over the internet.

The application module section 266 includes a number of application specific modules and integrated services for implementing specific functions of the brand resource management system 110. In the embodiment shown in FIG. 2, the applications modules section 266 includes: a Central Administration module 268, a Contract Management module 270, an Approvals module 272, a Sales Reporting module 274, a Budgeting and Forecast module 276, a Sales Analysis module 278, and a Digital Style Guide module 279. In addition, the application modules section includes integrated services for providing E-mail triggers in conjunction with events performed by the other modules. The specific number and types of modules included in the applications module may vary in different embodiments of the present invention.

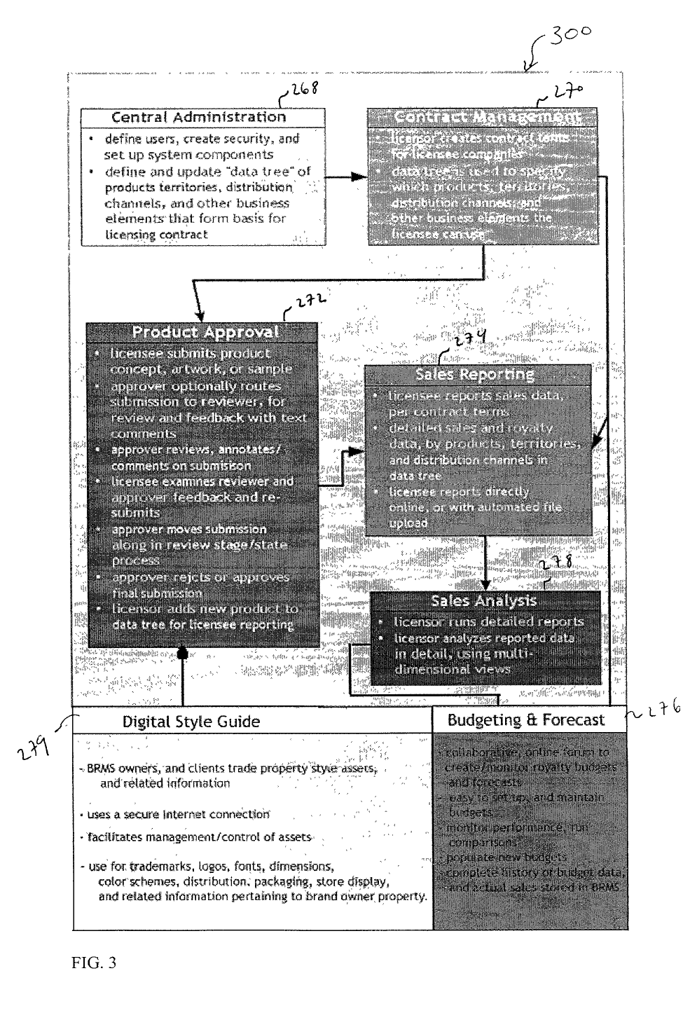

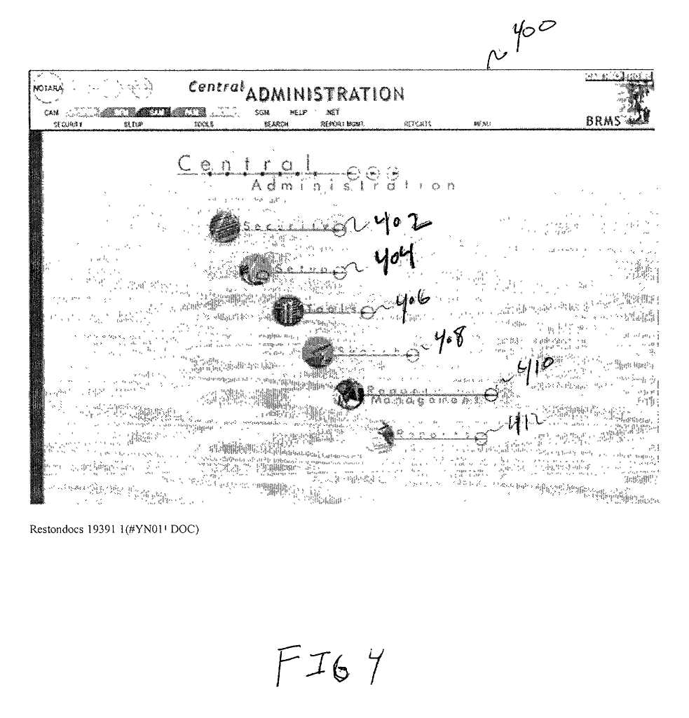

FIG. 3 is a flowchart 300 illustrating the general workflow of the brand resource management system. Flowchart 300 represents a general flow, and individual module functionality may be used in different sequences and combinations, as real world business situations dictate.

As shown in FIG. 3, a brand owner (or licensor) starts with the Central Administration module (CAM) 268. The brand owner uses CAM 268 principally to define users, create security, set up system components, and define and update “data trees” of products, territories, distribution channels, and other business elements that form the basis for a brand owner/partner contract.

After using CAM 268, the brand owner would use the Contract Management module (CMM) 270 to create contract terms for partner companies, and to use the data tree(s) to specify which products, territories, distribution channels, etc. the partner can use. Next, a partner and the brand owner use the Approvals module 272. More specifically, the partner uses the Approvals module 272 to submit product concepts, artwork, samples, etc for approval by the brand owner. In a licensing arrangement, after the products/concept is approved by the brand owner and the partner begins selling a licensed products, the partner uses the Sales Reporting module (SRM) 276 to report the sales data per the terms of the license. Next, the brand owner can use the Sales Analysis module 278 to analyze the data reported by the partner.

As shown in FIG. 3, the Digital Style Guide module 279 is used in conjunction with the PAM 272 and the Budgeting and Forecast module 274 is used in conjunction with the Sales Analysis module 278.

Each of the application modules is described below in greater detail.

Central Administration (CA) Module 268

FIG. 4 illustrates an exemplary home page 400 for the CA module 268. CA module 268 includes a number of sub-modules or tasks. These tasks include Security, Setup, Tools, Search, Report Management, and Reports. As shown in FIG. 4, home page 400 provides links 402-412 to access the sub-modules or tasks within the CA module 268.

Security:

The Security sub-module is two-fold: first, it allows an administrator to define the users of the application, and second, it allows the administrator to specify each user's access rights to different modules and tasks within modules. For example, a brand owner would specify as users certain employees of the brand owner and certain employees of a partner company.

Defining the users of BRMS means creating both individual users and user groups. Creating individual users is a straightforward process of identifying individuals by name, e-mail address, and additional personal and technical data. Defining user groups is also a straightforward process, involving three steps: naming the group; assigning one or more security keys to the group; and assigning individual users to group.

The purpose of user groups rests on the concept of security keys. Security keys provide access to specific modules and to tasks within modules. These keys are assigned to user groups as part of the group creation process. This means that any member of the user group “inherits” the security keys of the group, and thus has access to the modules and tasks associated with those security keys. This affords both flexibility and simplicity in setting up security configuration. An administrator can create groups for access to individual modules, to a combination of modules, or to a combination of tasks within and across modules. Similarly, for an individual user who needs specialized access to an unusual combination of modules and tasks, the administrator can create a user group with the required access rights and assign it a single member.

Setup:

The Setup sub-module enables the administrator to define and implement two key components of BRMS 110: (1) e-mail events, and (2) data trees.

The e-mail events component provides the automatic generation and routing of notification e-mail messages, to both a standard and customized list of recipients. The standard recipients are the owner and partner users defined to the application. The custom recipients are those you specify through the e-mail events task. These events that trigger the e-mail messages are built into the application, as part of module and task processing. Whenever one of these events occurs, an e-mail automatically goes to one or more predetermined users.

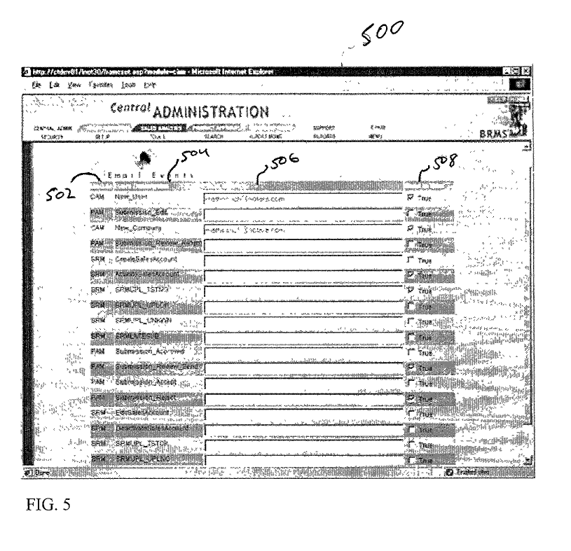

The e-mail events task involves two things: turning individual e-mail events on or off, and defining individual owner and partner users as custom recipients for e-mail events. This task is performed from an e-mail events page 500 (see FIG. 5), which is accessed by selecting the Setup link 404 on the Central Administration home page 400, and then selecting an E-mail link (not shown).

The e-mail events page 500 is a four-column table. The first two columns 502 & 504 list each module and its individual events that generate automatic e-mail notifications. The third column 506 provides a text box for entering custom e-mail addresses, to which an e-mail will be sent when the particular event occurs. The fourth column 508 is a check box that enables the administrator to turn e-mail notification on or off for each specific event.

A data tree, as used herein, is a visual representation of hierarchical data. In other words, certain data is displayed to the owner and partner users in the form of a tree. The data is stored in database 254, and an applet executing on a owner or partner workstation retrieves the data from the database 254 and displays it in a tree form (i.e., hierarchical form).

BRMS 110 includes multiple data tree types that are used in different parts of the application: (1) a product tree that displays the names of products; (2) a territory tree that displays the names of geographical areas; (3) a distribution tree that displays the names of specific distribution outlets; and (4) a time tree that displays reporting periods.

Tools:

The tools sub-module enables one to schedule the automatic execution of predefined action. When one selects the tools link 406 on the Central Administration home page 400, a scheduler page appears (not shown). The page has two parts, a top and a bottom. The top part displays a list of available actions that can be scheduled and a schedule action command button (not shown). Selecting one of the listed actions and activating the schedule action button causes a schedule action page (not shown) to be displayed. The schedule action page enables the user to schedule when and how often the action should occur. The bottom part of the scheduler page, is a running list of all the tasks currently scheduled for execution.

Table 1 shown below lists the actions that can be scheduled.

| Action | Description |
|---|---|
| SAM Cube Update | Automatically update a Sales Analysis Cube |
| | (discussed below) with the latest sales data |
| | captured from the partner. The Sales Analysis |
| | Cube is an OLAP database that arranges sales |
| | data according to multiple dimensions that |
| | correspond to different dimensional aspects, |
| | such as time, dollar amounts, products, |
| | geographical regions, and sales channels. Once |
| | the OLAP database is populated with data, that |
| | information can be displayed and navigated in a |
| | PivotTable. |
| CMM Contracts | Automatically generates an e-mail notification, |
| Expiring | to designated recipients, with a list of owner- |
| Notification | partner contract agreements that have expired on |
| | a predefined date. |
| CAM System Log | Automatically purges all data from the log file |
| Purge | maintained in the Central Administration |
| | module. |
| BFM Cube Update | Automatically update a Budgeting and Forecast |
| | Analysis Cube (discussed below) with the latest |
| | budgeting/forecast data captured from the |
| | partner. Like the Sales Analysis Cube, the |
| | Budgeting and Forecast Analysis Cube is an |
| | OLAP database that arranges data according to |
| | multiple dimensions, such as time, dollar |
| | amounts, products, geographical regions, and |
| | sales channels. Once the OLAP database is |
| | populated with data, that information can be |
| | displayed and navigated in the PivotTable. |

Search:

The search sub-module allows one to search the admin database 259 for individual users of the system, across all companies or in a single company. One can search by the user's first and last name, e-mail address, BRMS user name, logon date, and creation date.

Report Management:

The report management sub-module enables the user to define one or more report groups for each module and to define one or more reports for each report group. A report groups comprises a set of related reports. That is, the individual reports in a group target specific information from different perspectives. A user can create report groups and reports for any available module. Then, from within that module, both owner and partner user can run the reports.

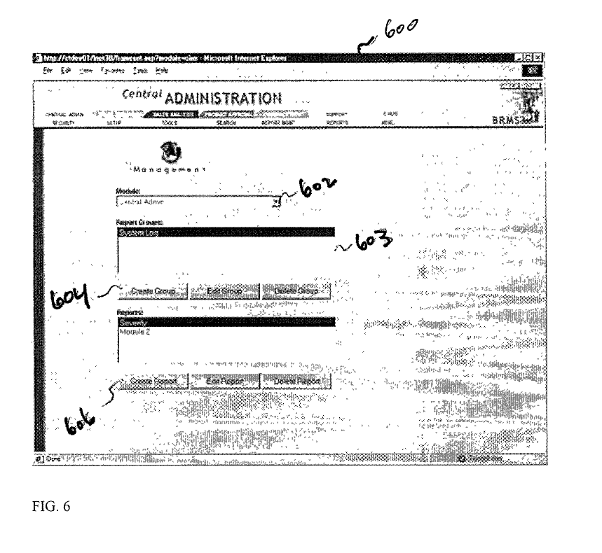

Owners work with report groups and reports using the report management page 600 (see FIG. 6). From the report management page 600 the user can create, edit, and delete report groups for each module.

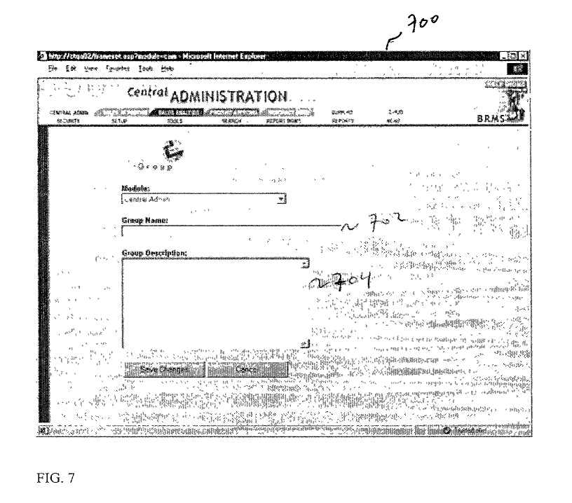

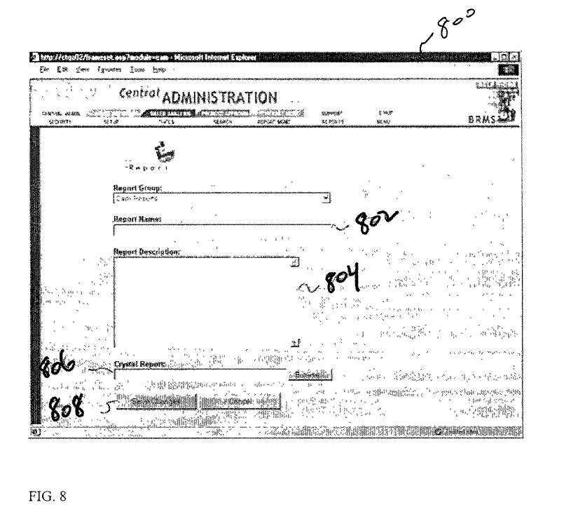

To create a report group for a particular module, the user opens the module drop-down list 602, and selects a module from the drop down list. The user then activates the create group button 604. This causes the create/edit group page 700 (see FIG. 7) to be displayed. The create/edit group page 700 allows the user to enter a name for the group in the group name text field 702 and to enter a description for the group in the group description text box 704.

To create a report and include it in a particular report group, the user first selects a report group from a report group list 603 that is displayed on the report management page 600 and then activates the create report button 606. After activating the create report button 606, a create report page 800 is displayed. The create report page 800 allows the user to enter a name for the report in the report name text field 802 and to enter a description for the report in the report description text box 804. After naming the report and providing a description of the report the user would either enter the file name of a pre-existing Report (preferably a Seagate Crystal Report), or if the report was for the Sales Reporting module, the user would enter a multidimensional expression (MDX) query that defines a report written using the MDX language.

Reports:

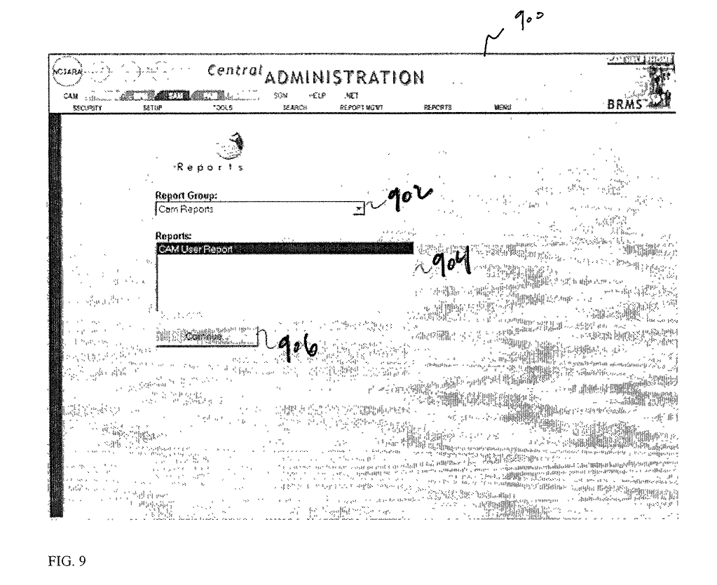

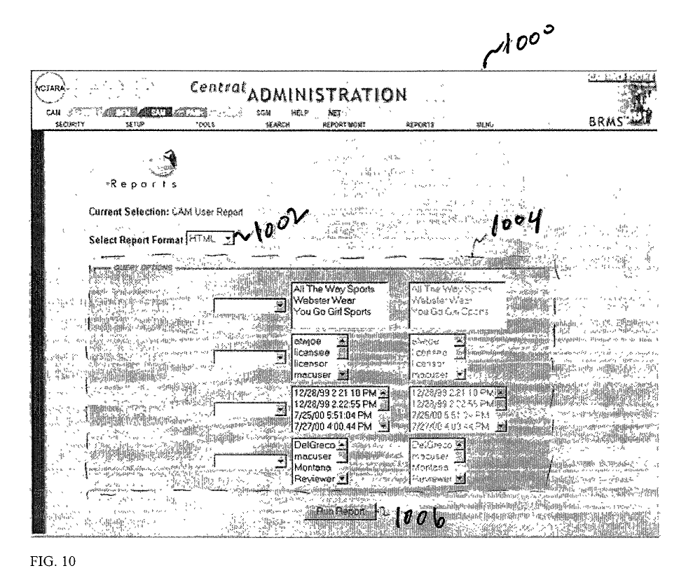

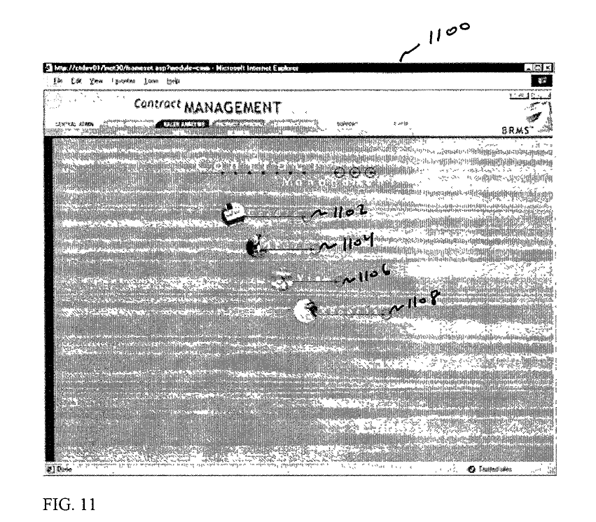

The reports sub-module 412 is used to select a report, select the output format of the report, build a query of parameters to define the report, and generate the finished report. The procedure for accomplishing this is as follows. First the user selects the reports link 412 from CAM page 400. This causes a reports page 900 (see FIG. 9) to be displayed. Next, the user selects a report group using the drop-down list 902. Upon selecting a report group, the list of reports that is included in the selected report group is displayed in the reports text area 904. The user would then select one of the listed reports and activate the continue button 906. After activating the continue button a second reports page is displayed. The contents of this page depends upon the report that was selected. FIG. 10 illustrates an example second reports page 1000. Reports page 1000 includes a report format drop-down 1002 for allowing the user to select a format for the selected report. The page 1000 also includes a query options section 1004 for allowing the user select among various query options. Lastly, page 1000 includes a run reports button 1006. Upon activating button 1006 the system generates the report using the selected format and query options.

Contract Management (CM) Module 270

FIG. 11 illustrates an exemplary home page 1100 for the CM module 270. CM module 270 includes a number of sub-modules or tasks. These tasks include Create, Edit, View, and Reports. As shown in FIG. 11, CM home page 1100 provides links 1102-1108 to access the sub-modules or tasks within the CM module 270.

Creating a contract:

Contracts form the basis of a business relationship between a brand owner and a partner of the brand owner. A contract identifies products, territories, distribution channels, and other business items that govern the business relationship, and it also specifies detailed business thresholds and royalty data.

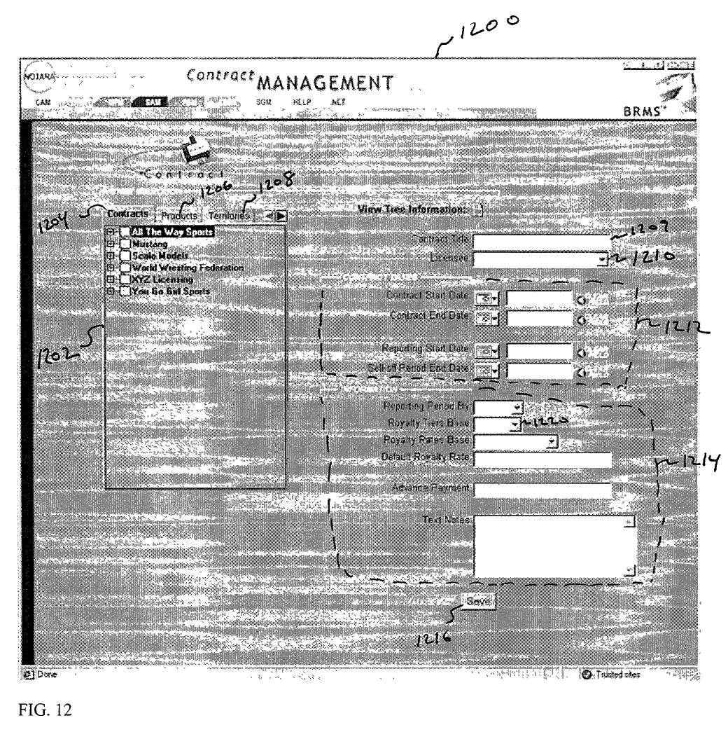

Creating a new contract is a multi-step process. It starts on the create contract page 1200 (see FIG. 12). This page is displayed when the user selects the create link 1102 on the CM home page 1100. The create contract page 1200 enables the user to define the fundamental elements of a contract.

Referring now to the create contract page 1200, a left-hand pane 1202 is used to display various data trees, such as a contract data tree, a products data tree, and a territories data tree. To view the contracts data tree the user would select a contracts tab 1204. Similarly to view the products data tree and the territories data tree, the user would select a products tab 1206 and territories tab 1208, respectively.

The first step in creating a contract is to select elements from the trees. These selected elements form the basis of the contract-that is, elements such as the products the partner can sell are selected from the products tree, the territories where sales are authorized are selected from the territories tree, and the distribution channels to be utilized are selected from a distribution tree (not shown).

After the user makes his or her data tree selections, the user must then name the contract and specify some basic information such as contract dates and royalty information. The contract title or name should be descriptive and recognizable, and it must be unique. The contract title is entered into a contract title text field 1209. Once the contract is named, the licensor (i.e., brand owner) needs to specify the other party to the contract using a drop-down list 1210. After naming the contract and specifying the licensee (i.e., partner), four contract dates are specified using the contract dates text fields 1212.

The four contract dates that should be specified are: (1) the contract start date—date on which the contract terms take effect; (2) contract end date—date on which the contract terms expire; (3) reporting start date—date by which the partner must begin reporting sales data to owner, as specified in the contract, either monthly, quarterly, or yearly; and (4) sell-off period end date—date on which the sell-off period expires.

Once a contract has reached the contract end date, the contract is normally considered to have expired. In some cases, an owner may allow a partner to continue selling products and report sales, selling off the remaining inventory. This can be accomplished within the CM module 270 through the concept of sell-off periods.

The sell-off period end date must always be on the same as, or later than, the contract end date. If the sell-off period end date is the same as the contract end date, then there is no sell-off period. In this case, once the contract end date is reached, the contract is considered to have expired. If the sell-off period end date does not equal the contract end date, then once the current date equals the contract end date, the contract is considered to be in the sell-off period. Once the sell-off period end date is reached , the contract has expired. Date functionality for contracts will be driven by the sell-off period end date.

After specifying the contract dates, the user should then specify royalty information. The royalty information is specified using the royalty information text fields 1214. The royalty information text fields 1214 includes fields for specifying the following information: (1) reporting period—the regular and recurring period for sales data reporting (e.g., monthly, quarterly, yearly); (2) royalty tiers base—the basis used for the various royalty tiers in the contract: money or units; (3) royalty rates base—the basis used for the various royalty rates in the contract: percent or money per unit; (4) default royalty rate—the rate applied to all products sold, exclusive of any exceptions specified elsewhere in contract; (5) advance payment—amount partner will pay owner up front; and (6) text notes -additional information regarding the contract terms.

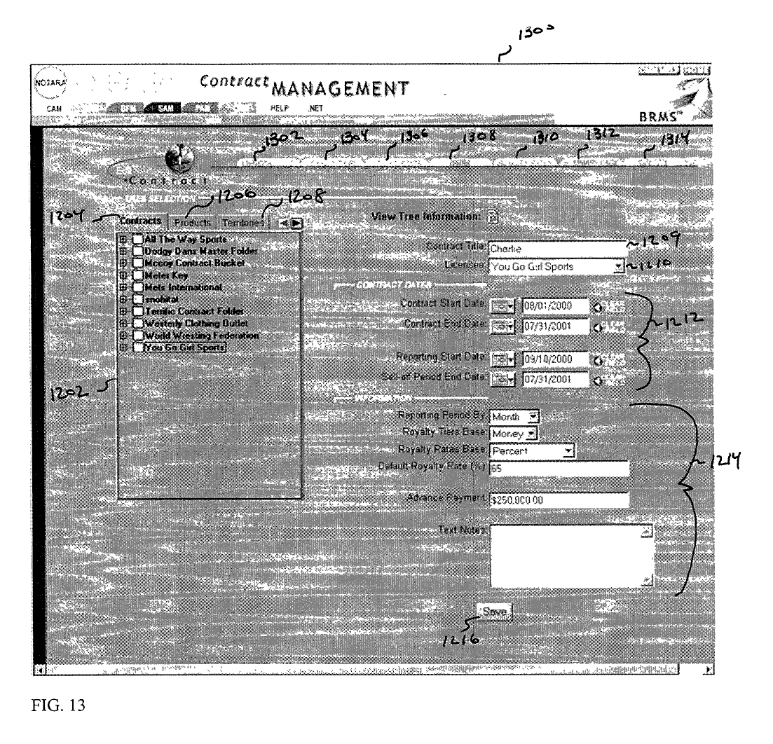

The next step in the contract creation process is to activate a save button 1216, which is located at the bottom of the create contract page 1200. After activating save button 1216 an edit contract page 1300 (see FIG. 13) is displayed.

Across the top of edit contract page are seven tabs: (1) general info 1302; (2) royalty tiers 1304; (3) time periods 1306; (4) GMRs (guaranteed minimum royalty) 1308; (5) royalty rates 1310; (6) summary page 1312; and (7) custom 1314.

Each tab has its own information for either reviewing the contract data, or further defining the contract. The first tab, general info 1302, is opened by default. It contains the data that was just selected and entered on the create contract page 1300. From here, the user activates each tab in turn and enters the required information.

It should be noted that entering information into these tabs is NOT mandatory for creating a viable contract. Adding the additional data to these tabs, however, does help an owner create a more detailed, structured, and ultimately effective contract. That is, the initial page (create contract page 1200) is all that is required to create the contract initially; once that page is saved, the edit contract page 1330 is displayed in order to enhance and augment the initial contract.

The general info tab 1302 is opened by default when the create contract page 1300 is first displayed. It contains the data that was just entered on the create contract page 1300. The data tree in the left-hand pane 1202 can be opened to the products tab 1206 to display the product or products selected for the contract that is being created. When one clicks the other tabs (e.g., territories 1208) in the left-hand pane 1202, they too are opened to show the items one has selected for the contract.

From the general info tab 1302, one can revise any of the initial contract information entered using the create contract page 1200. After making any changes on this general info tab or any of the tabs on the edit contract page 1300, one needs to click the save button 1216 to save the changes.

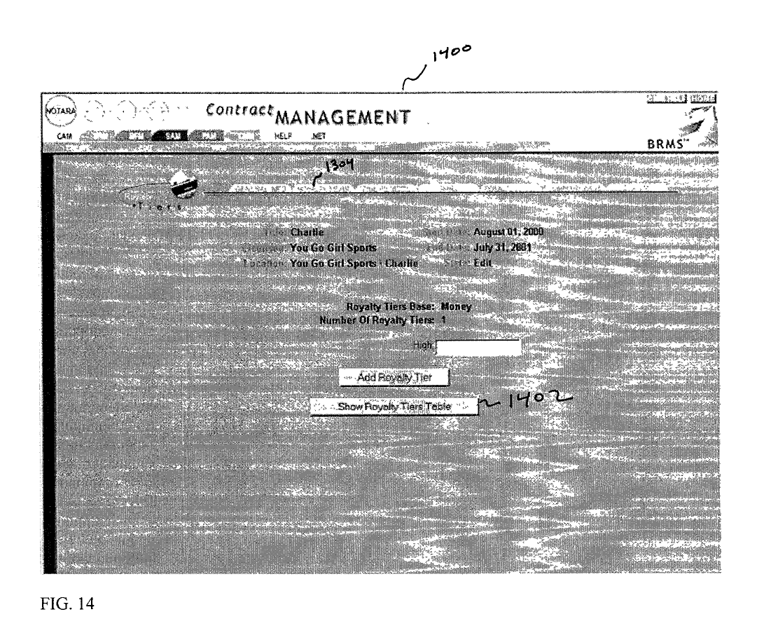

After selecting the royalty tab 1304, a royalty tiers page 1400 (see FIG. 14) is displayed. Royalty tiers page 1400 enables one to define or edit a hierarchy of royalty tiers. Each tier represents a dollar range or unit range of sales volume. Within a given tier, the partner will pay a specified royalty rate. This can provide incentive for increased sales volume. At lower volume the royalty rate can be set high, and as sales volume increases, that royalty rate can become progressively smaller. In essence, the more the partners sell, the less they pay in royalties. And of course, the more the partners sell, the more income for both partner and owner.

The CM module 270 allows contract royalty rate exceptions to be based on two different types of royalty tiers, money based or unit based. The user selects the type royalty tier on the create contract page 1200. For a given contract, royalty tiers will be either money based OR unit based, not both. During initial contract definition through the create contract page 1200, the user selects the royalty tier base for the contract through the royalty tiers base field 1220.

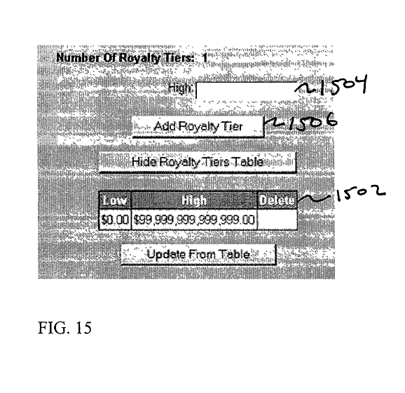

The first step in creating royalty tiers is to activate the show tiers table button 1402 so that the existing royalty tiers table 1502 (see FIG. 15) will be displayed. If this is the first time through, the table shows that the contract starts off with a single default tier from $0.00 to $99,999,999,999,999.00.

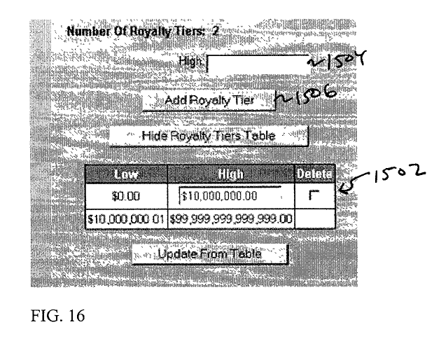

One would probably want to break that range up a bit into some realistic ranges. To do that, the user enters a dollar value into the high text box 1504 (for example, the user might enter a value of $10,000,000), and then activates the add royalty tier button 1506. As shown in FIG. 16, the tier table 1502 updates to show the added tier, or dollar range.

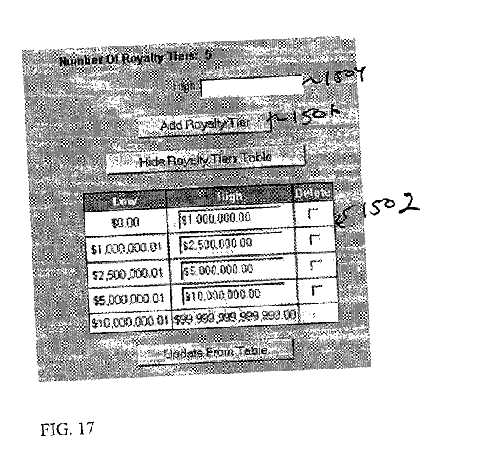

The user can add as many intermediary tiers as he or she thinks are needed to cover the projected range of sales activity for this contract. The user might start with a single tier capped off at $10,000,00, and then add additional ones in between as shown in FIG. 17.

The tier table 1502 shows up again under the royalty rates tab 1310 (described in more detail below), where the user specifies actual royalty rates for the contract. At that juncture the user can select each of these royalty tiers in turn, and set a particular rate for each. Again, this enables the brand owner to provide a flexible contract agreement, with built-in incentives in the form of royalty rate reductions on volume sales.

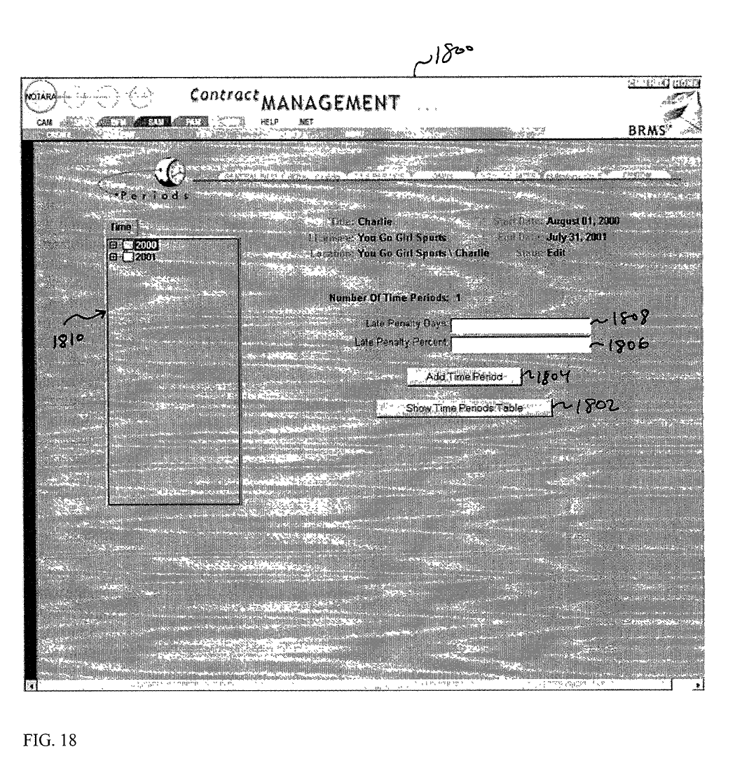

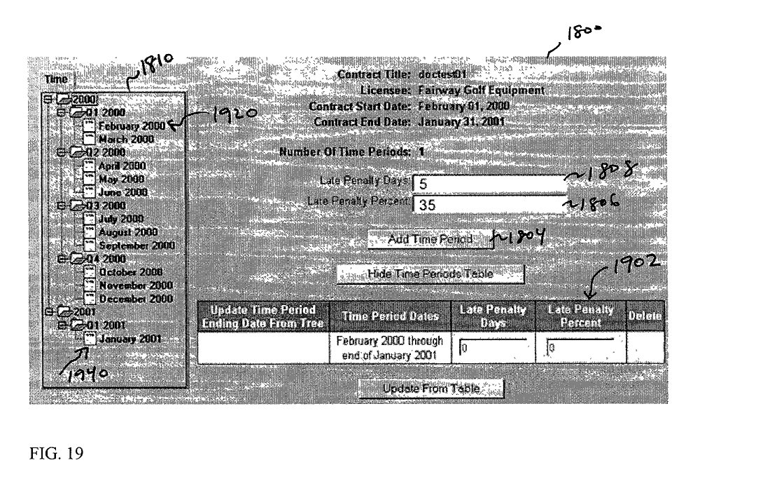

Time Periods: after selecting the time periods tab 1306, a time period page 1800 (see FIG. 18) is displayed. Time period page 1800 is used to define time periods for the contract. The time periods page 1800 has a button 1802 for showing a table of time periods; a button for adding time periods 1804; text fields 1806 and 1808 for defining more details about those time periods; and a data tree 1810. Data tree 1810 is a time tree, arranged in a hierarchy of nodes and leaf items that reflect the dates specified for the contract (e.g., contract start/stop date, reporting start date, etc). The tree nodes and leaf items in the time tree 1810 reflect the specified start and stop dates and reporting dates. For example, in the illustration of a time tree 1810 shown in FIG. 19, the first leaf node 1920 is February, 2000. This indicates the starting date of the contract. The final leaf node 1940 is the month of January, 2001, which identifies the end date of the contract.

The purpose of time periods page 1800 is to break the one long time period of the contract into smaller ranges or time periods, in effect creating different time period “subsets” in the contract. This would enable the user to add more detail to the contract over time, even after the contract has started.

When the user defines one of these time period subsets, he or she has the option of defining penalty information to be associated with it: the number of days in the grace period, and the payment penalty percent when the grace period is exceeded. The grace period—or late penalty days as it's called—is the number of days after the required reporting date that the penalty payment kicks in. And the late penalty percent is just that-an interest penalty payment on the reported sales amount.

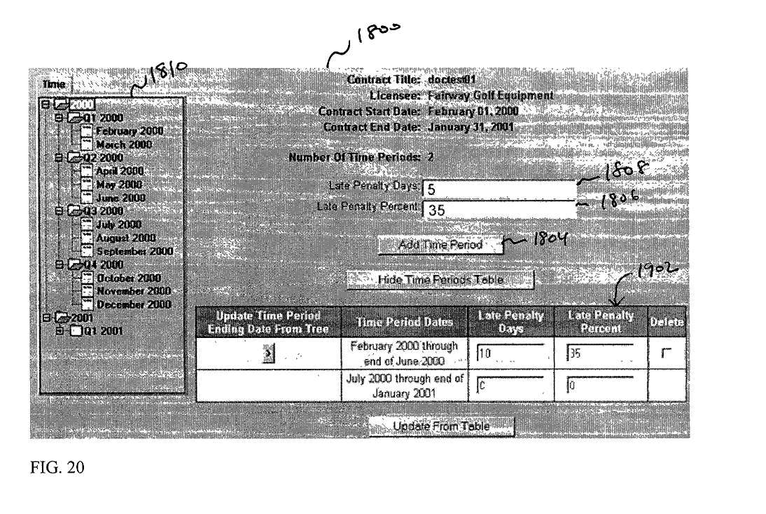

The first step in creating time periods for the contract is to activate the show time periods table button 1802 so that the existing time periods table 1902 (see FIG. 19) will be displayed. In our example, the table 1902 states that the contract runs from February, 2000 through January, 2001. The next step is to enter the number of late penalty days in text box 1808 and the late penalty percent in text box 1806. The next step is to select from time tree 1810 a leaf node (e.g., month) other than the last leaf node and activate the add time period button 1804. This splits the original time period in two, with one period running from the original start date to the selected leaf node/month, and the second running from the next month to the original end month. In our sample, the period from February, 2000 through January, 2001 has been split into two periods: from February to June, and from July to January, 2001 as shown in FIG. 20.

These steps can be repeated a second and third time to carve the original time period up into smaller and smaller subsets, each with its own unique penalty data. Suppose, for example, that one wanted to add a third time period subset to our sample shown in FIG. 20. The table always works off the month you select from the time tree 1810. That month is matched up against the existing time periods. Whichever existing time period contains the selected month is the one that is split up. In our sample shown in FIG. 20, we have two time periods. If one selects September from the time tree 1810, then the existing period containing September is split in two. The first month in the existing period remains the starting point (July), and the month selected becomes the end month for the new period (September). In our sample, the new period runs from the original start date of July through the new end date of September. And, the old (existing) time period gets a new start date of October, which is the month immediately following the one selected.

The defined time periods, like the royalty tiers, show up when it comes time to define specific royalty rates.

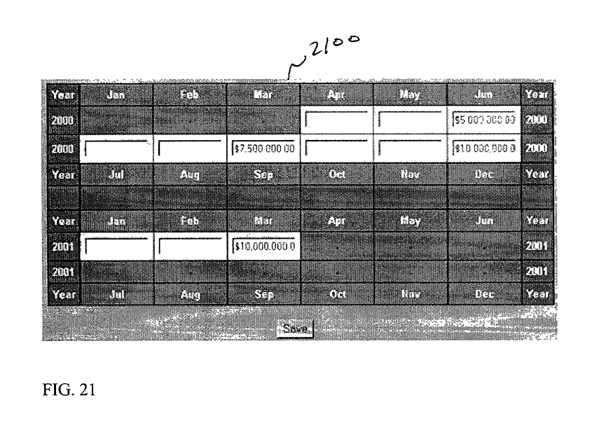

GMR Tab: after selecting the GMR tab 1308, a GMR page 2100 (see FIG. 21) is displayed. GMR page 1800 is used to define Guaranteed Minimum Royalty (GMR) amounts in the contract. Guaranteed minimum royalties are guaranteed royalty payments made by the partner under the terms of the contract. Regardless of actual sales, the partner will be required to pay this amount as it is specified in the contract.

The royalty rates tab 1310 enables the user to set custom royalty rates for selected items (e.g., products, time periods, royalty tiers) in the contract. These custom royalty rates override the default rate set in the create contract page 1200. That default applies across the board to all items, unless the user specifies another value in the royalty rates tab.

The royalty rates tab lets the user select a subset of the data tree elements that constitute the contract, and set a specific royalty rate for that subset. For example, the contract might cover two or more products and distribution channels, and one might want to override the default by selecting just one of the products and just one of the channels, and setting a specific royalty rate.

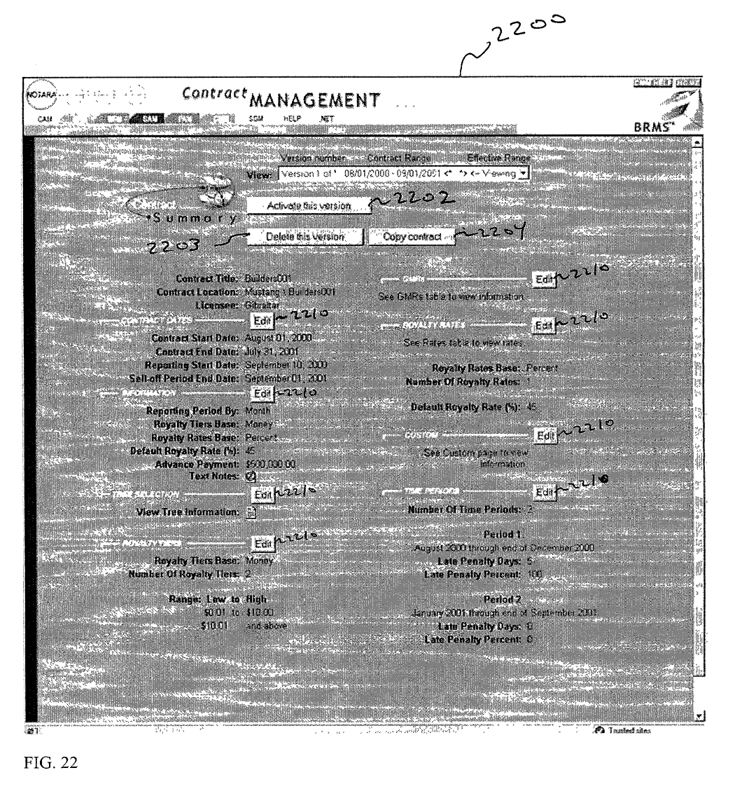

Summary: after selecting the summary tab 1312 a summary page 2200 (see FIG. 22) is displayed. Summary page 2200 displays a full snapshot summary of the contract as it has been created. All of the data tree items, and all of the information entered into the tabbed dialogs are available for a final review before the contract is activated. The user can click an edit button 2210 to display the information for any of the listed items. Summary page 2200 also provides a series of command buttons, which the user uses to finalize the creation of a contract. An Activate button 220 puts the contract into the active state, which makes it available for full processing within the CM module 270. A Delete button 2203 removes the contract from the CM module 270. A Copy button 2204 creates a new, original copy of the contract.

Editing & Viewing Contracts:

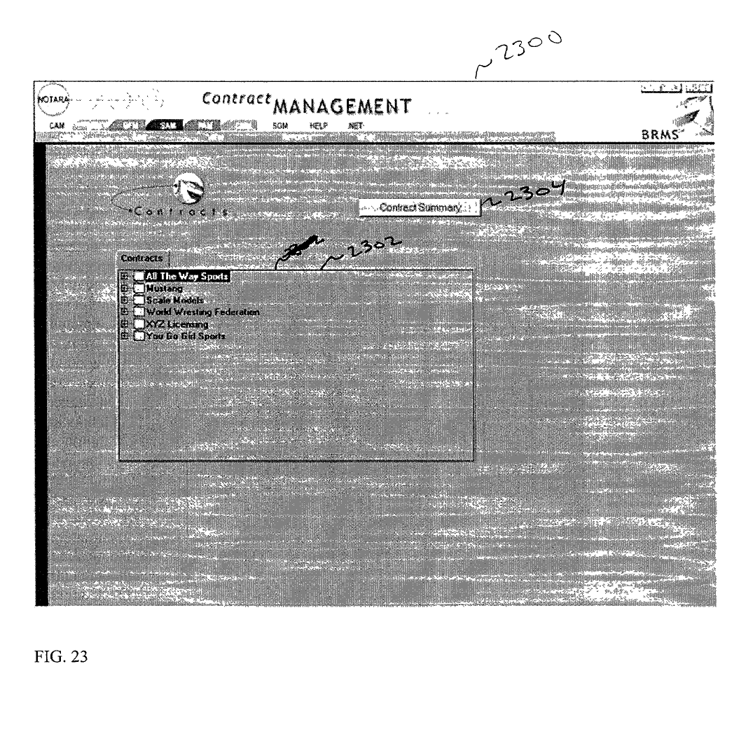

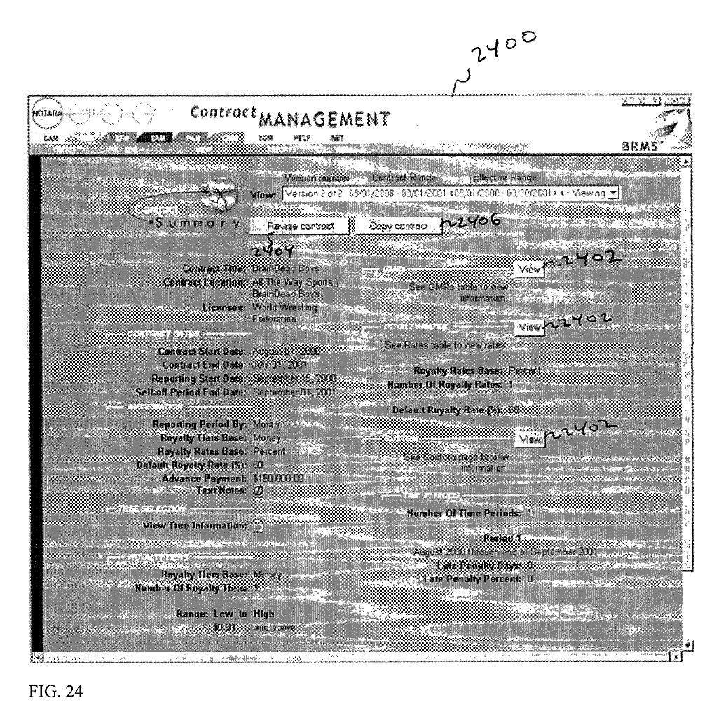

The edit and view tasks provide the exact same functionality; either one can be used to review the details of a selected contract, and then move into the edit mode to make changes. When the user clicks the Edit or View link 1104/1106 from the contract management home page 1100, a contracts page 2300 (see FIG. 23) is displayed. The contracts page 2300 has a data tree 2302 from which the user can view all of the contracts that have been created. Page 2300 also has a contract summary command button 2304. To edit or view a contract the user simply selects one of the contracts from the tree 2302, then activates the command button 2304. This causes a contract summary page 2400 (see FIG. 24) to be displayed. This page 2400 provides view command buttons 2402 that allow the user to access the detailed contract information.

The only way to make changes to a contract is to create a new version or a new copy. If the user is editing or viewing an original (version 1 of 1) contract, or the latest version of a contract (version 2 of 2, version 3 of 3, etc.), the contract summary page 2400 will include a command button 2404 for revising the contract and a command button 2406 for copying the contract. If the user is looking at a contract that is NOT the latest version (version 2 of 3, for example), then the contract summary page will include only a command button for copying the contract because a user can only create a new version from the original or latest version of a contract. In any other instance, the user needs to make a copy of the contract.

When the user activates the Revise Contract button 2404, a new version of the contract is created. When the user activates the Copy Contract button 2406, the user is creating an entirely new contract, which the user can save under a new name. Activation of either of these command buttons causes the summary page 2400 to go into edit mode. This means that the top of the page will include an additional “Activate this version” and “Delete this version” command buttons (not shown), and the View command buttons 2402 are changed to Edit command buttons 2402. From this point, the user can move through the contract, review and change information, and then activate the new version with a new effective date.

Reports:

To run reports from within the CM module, the user selects the reports link 1108. This causes a reports page 4700 (see FIG. 47) to be displayed. The reports page enables the user to select a report and run the selected report.

Approvals Module 272

The Approvals module 272 makes submission, review, feedback, and approval of product designs, from business partners and third-parties to brand owners, a simple, fully automated, and almost instantaneous process. Using the power and presence of the Internet, the Approvals module 272 connects everyone in the business partner, third party, and owner organization in an immediate, roles-based (rather than rules-based), graphical communications channel that makes the traditional off-line submission and review process outdated.

The Approvals module 272 provides a series of tasks for a submitter, a Reviewer, and an Approver, which, taken together, create a customized, precise process for electronically submitting and reviewing product ideas and artwork renderings in a back-and-forth, iterative exchange that culminates in an approved product. Built-in, automatic e-mail notifications guarantee that all parties stay informed and in the loop throughout the entire approval process.

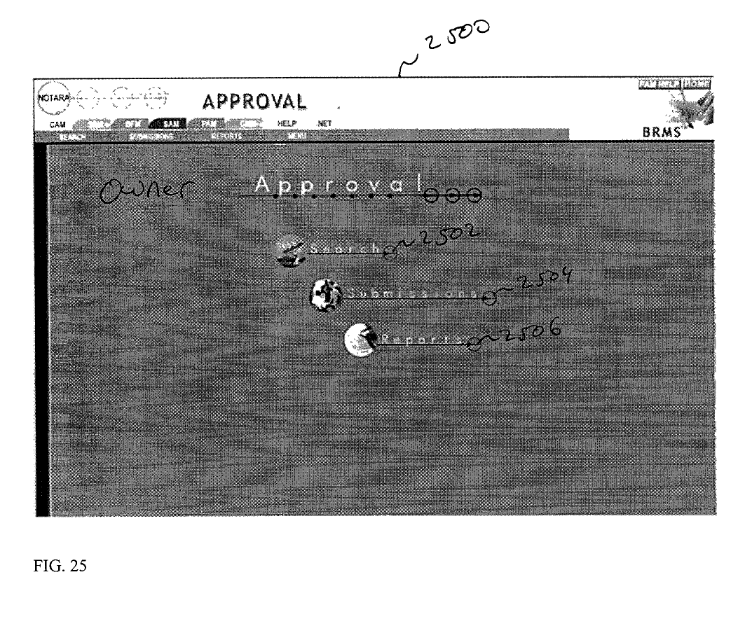

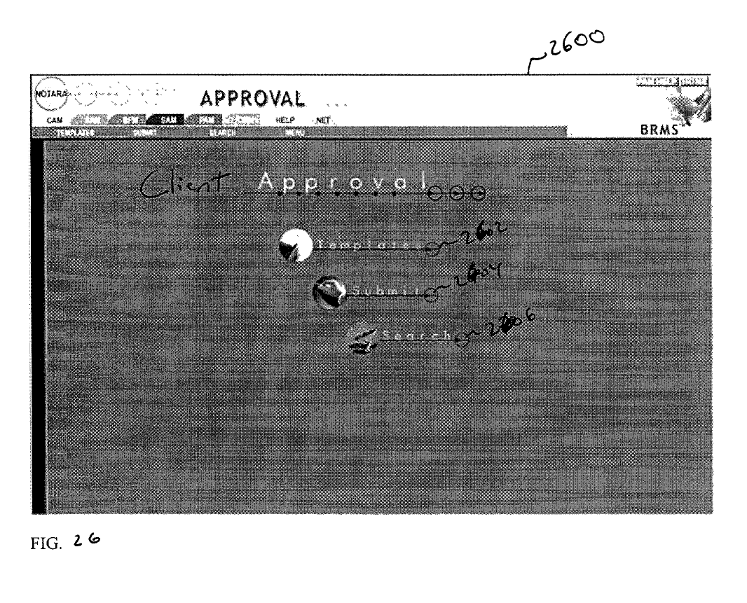

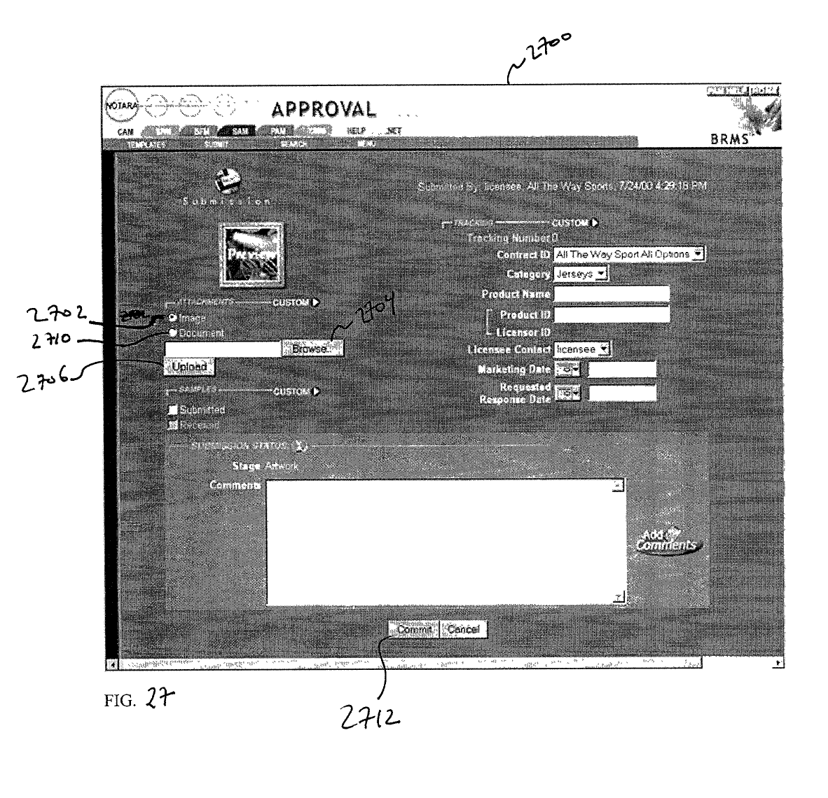

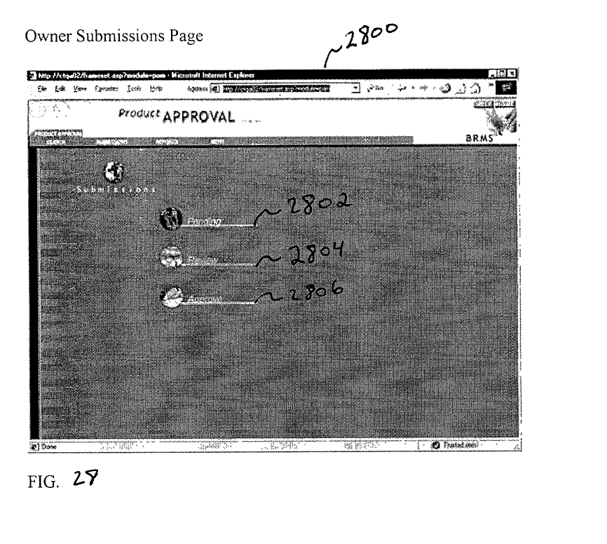

The Approvals module 272 actually consists of two modules: an owner Approvals module and a business partner Approvals module. FIG. 25 illustrates the home page 2500 for the owner Approvals module. FIG. 26 illustrates the home page 2600 for the business partner Approvals module. The owner Approvals module consists of three sub-modules or tasks: search, submissions, and reports. The owner Approvals module home page 2500 includes links 2502, 2504, and 2506 for accessing the three tasks, respectively. The business partner Approvals module also includes three sub-modules or tasks: templates, submit, and search. The business partner Approvals module home page 2600 includes links 2602, 2604, and 2606 for accessing the three tasks, respectively.

With the templates task, business partners can use product approval templates to package up all of the information and image samples required by owners for a product submission, and then submit this electronically for immediate owner review. Product approval templates are customized forms, created by or for owner organizations, and used by business partners to submit product concepts, artwork, or samples for review and approval. The product approval template is a fill-in electronic form that captures the required information about the submission, and also enables the business partner to attach actual artwork images that depict the product for which approval is sought.

With the submit task, business partners can submit a standalone image, separate from the template. In either case, the template with image sample or the standalone images are stored electronically in the approval database 255, and available for download and review by the owner at the click of a button.

Owners use the search task to display a list of submissions from the business partner, and then use the submissions task to access, open, and review the contents of these submission packages. Owners can make text comments or image markups to the submitted package. Business partners can then retrieve the package with these comments and markups, and use them as the basis for design modifications needed for final approval. This iterative exchange can be repeated as often as necessary, to fine tune the submission and get it approved.

Advantageously, the iterative process of reviewing and approving of concept artwork, product prototypes, or product samples happens without shipping and packaging, without a manual paper trail, and in a fraction of the time used for a manual process. The Approvals module 272 likewise removes the guesswork from the product development process. It logs all revisions, and keeps tabs on who made the change, what everyone thinks of it, who has signed off on it. Owners and business partners alike can track the development process at every step, monitor any changes, and share decisions with the team quickly. The Approvals module 272 also includes a reports task that provides detailed, audit trail information on submissions made by the business partner, and its current status within the review and approval cycle.

The Approvals module 272 tracks the approval process of a particular submission by assigning a specific status to each submission. As the submission moves along in the approval process, the status changes in order to reflect the submission's current position in the process. A submission's status is described in two terms: “stage” and “state.” The stage refers to the life cycle of the submission, while state refers to the disposition of the submission within a given stage. In other words, within each stage, a submission may move through several different states.

Stages

Stages define the life-cycle of the submission, from its initial submission, through its review cycles, and on to its final approval or rejection. The Approvals module 272 includes a flexible scheme of default or baseline stages but also supports the implementation of additional user-defined stages.

For example, an owner may wish to use a four-stage submission hierarchy in which the business partner is required to (i) submit a description of the product in a “Concept” stage, (ii) submit a rendering of the product in the “Artwork” stage, (iii) continue on to a “Pre-Production stage,” and (iv) finish with either an “Approved” or “Rejected” stage. Additional stages might also be included, in any number or sequence, as long as the stages support and reflect the way the owner does business with business partners. The rejected stage means the submission is dropped from the system, and will not be considered for re-submission. The approved stage means the owner accepts the submission as it was last submitted.

Not all stages will necessarily be used for a particular submission. Using the example above, the business partner might start the process with the Artwork stage, as opposed to the Concept stage. Likewise, a owner may review artwork, and then move to the Approved stage on that basis alone. Or an owner might jump the process right from Concept to a Pre-Production sample. In other words, the life cycle stages may vary from submission to submission.

States

States work in conjunction with stages. While stages are intended to represent distinct points within a submission life cycle, states are intended to represent distinct points within each stage. Within a stage, the submission may exist in one of five states: “Pending,” “In Review,” “Re-Submit,” “Stage Approved With Changes,” and “Stage Approved.” (It is important to note, however, that the Rejected and Approved stages are termination points for the submission, and thus do not have an associated state.)

Progression through the submission life cycle within each stage begins with the Pending state, which applies automatically to a submission as soon as it is submitted. The submission remains in the Pending state only until it is claimed, or opened for review, by an authorized Approver. At that point the Approver will change the state to In Review and the submission will be associated with the particular Approver who claimed the submission.

The Re-Submit state is manually applied by the Approver when the Approver identifies changes that must be made to the submission. The submission thus remains in the same life-cycle stage, and must be submitted again with modifications. The Stage Approved state is manually assigned by the Approver when the submission is deemed acceptable. At this point, the submission can move to the next life-cycle stage (for example, from Concept to Artwork). The Stage Approved With Changes state means the submission is Stage Approved pending completion of modifications that are detailed by the owner. When these are completed, the submission moves on to the next stage.

As a submission moves through the review process, the Approver manually controls the stage and state designations, except for when an Approver first claims a submission, in which case the submission is automatically in the initial Pending state. At this point the Approver may distributed the submission to multiple parties for review. These Reviewers may offer comments and suggestions for changes or additions to the submission, and these changes can be directly incorporated onto the submitted text or graphics. The state at that point might be manually changed to Re-Submit, indicating to the business partner that changes will be required.

A key to understanding the flow of stages and states is to understand the concept of Reviewers and Approvers, within the flow of the submission review process. Reviewers and Approvers are owner users with different security key access rights: a Reviewer only has access to the review task, while the Approver has access to the approve task as well as the review task. Two key distinctions between Approvers and Reviewers are how they first access a submission and what they can do with it once it is accessed.

Approvers access a submission by “claiming” it from a list of all submissions that exist in the “pending” state. Every partner submission is assigned the pending state when it is first submitted. These show up on a list that the Approver can access. The Approver can click on a listed submission to open it in a read-only view. Multiple submissions may exist at any given time, and the pending list enables an Approver to sift through those pending submissions and to find those which he or she is responsible for approving.

From this read-only view of the submission, Approvers can click an Edit command button to switch to an edit view, which means they can enter comments and mark up the submission with edits, updates, and comments. The Approver can also “route” the submission to designated Reviewers for additional review. When the Approver clicks a commit button, the submission is formally “claimed” and any edits, updates, and comments are saved as part of the submission, and the submission is routed to any designated Reviewers. The Approver can also change the state and stage of a submission, and move it through the review process.

Unlike Approvers, Reviewers do not claim a submission from the pending list. As was stated earlier, Approvers can “route” a submission to the Reviewer as part of claiming it for approval. The Approver selects the Reviewer's name from a “Route To” field on the submission form. This automatically generates an e-mail notification that informs the Reviewer that a submission has been sent for review. At this point the Reviewer can access the submission. The Reviewer cannot change the state and stage of a submission. The job of the Reviewer is to review and comment on submissions routed to them by an Approver.

In a typical submission and review scenario, an Approver might route the submission to several Reviewers, each with specific responsibilities, such as a legal review and typographic review. These Reviewers would be notified by automatic e-mail that the submission had been sent out to them for review. Each Reviewer in turn would open the submission, and comment on the submission.

We will now describe a sequence of interactive steps that typify the submission and review of a product within the Approvals module 272. This workflow includes three users: a partner with submission rights, an Approver, and a Reviewer. This workflow scenario also uses the default review stages and reviews states described above.

The steps in the workflow cover the following actions: (1) initial submission of a stand-alone image and submission form (i.e., completed template form); (2) retrieval and initial review of the submission by the Approver; (3) editing and markup of the submission by the Approver; (4) routing of the edited submission to a Reviewer; (5) retrieval, review, and addition of comments to the submission by the Reviewer; (6) retrieval of the reviewed submission by the Approver, and change to submission state to move it along in the review process; (7) delegation of the submission to another Approver; and (8) review by partner of the updated submission items and comments from Approver and Reviewer.

It should be noted that the stages and states used in this workflow presentation are samples; actual owner stages and states may be different.

Workflow Step 1: The workflow process starts with the partner using the Approvals module 272 to make a submission. The item(s) being submitted may include a submission form (i.e., completed template) or stand-alone image or both. For purposes of this discussion, we will assume that both a submission form and a digital image jpeg file, gif file, etc.) are submitted. In preparation for submitting an image, the partner will have stored the image locally on the partner workstation 130.

To begin the submission process, the partner uses his or her browser software 125 to request that the server transmit the partner Approvals module home page 2600. This home page is then displayed to the partner. The partner then activates the templates link 2602, which causes a templates page (not shown) to be displayed. The template page displays a list of templates that the partner can chose from by selecting and opening a particular template from the list. A template is a means for the partner to enter the detailed data required by the owner for an acceptable submission. The specific information required by the template reflects the particular needs of the owner organization, and will vary from owner to owner. The details in the template depend also on the contract terms negotiated between the owner and partner. The available templates are customized a number of ways: by the specific owner organization, and its specific information requirements for a submission; by product category of the submission; and by the stage and state of the submission within the review and approval process. On download, the selected template is preferably opened in the Adobe Acrobat® viewer or Acrobat® Reader.

The partner opens the template form, and enters the required information. The completed template form is saved by the partner to local storage. A completed template is referred to as a “submission form.” After entering the required information into the template form and saving the form to local storage, the partner returns to the partner approval home page 2600 and selects the submit link 2604.

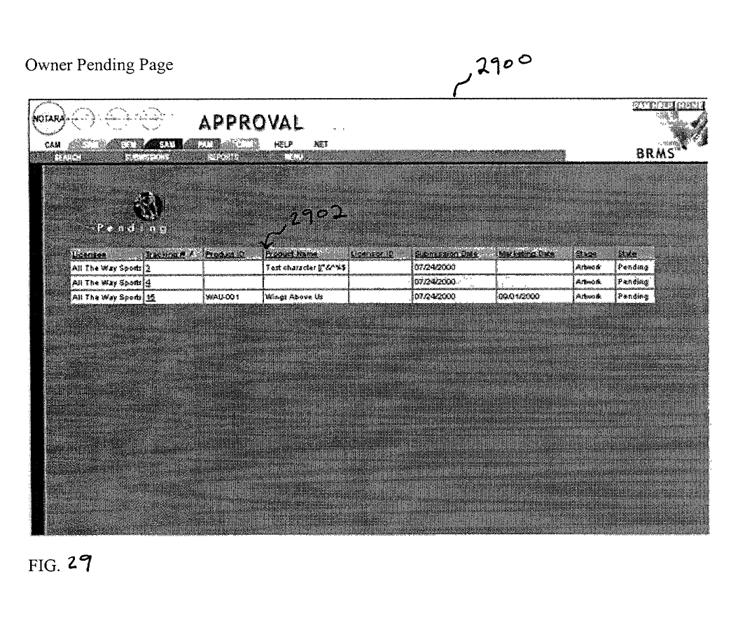

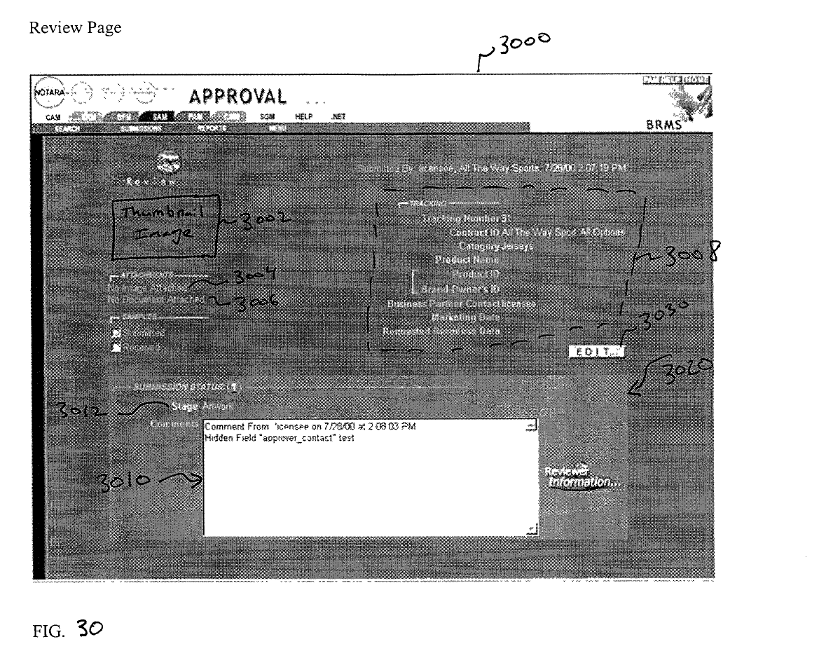

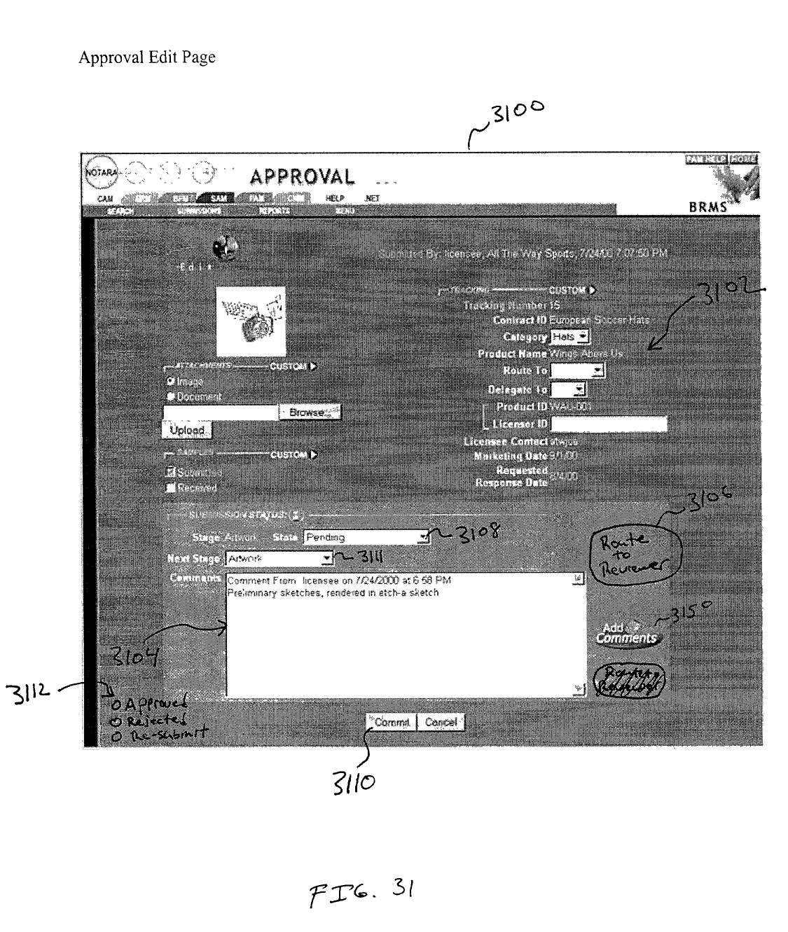

Upon selecting the submits link 2604, a submit page 2700 (see FIG. 27) is displayed in the partner's browser. From here the partner fills out the information required by the submit page 2700. This information includes: a contract ID, a product category, a product name, a product ID, a licensee contact, a marketing date (the projected date for bringing the approved product to market), and a requested response date (the desired date for receiving feedback concerning the submission).

Next, the partner selects an image radio button 2702, and then activates a browse button 2704 to locate the image file to be submitted. The partner then activates an upload button 2708 to upload the image to the server application 145. The partner then selects the document radio button 2710, and activates browse button 2704 to locate the submission form. Next, the partner activates the upload button 2708 to submit the submission form to the server. Lastly, the partner activates a commit button 2712 to save the submission in the module.

At this juncture, the submission exists in the “concept” stage, and in the pending state. The stage for an initial submission always defaults to the first stage defined by the owner, which in this case is concept. The state, which is not configurable, defaults automatically to pending for an initial submission. All initial submissions are grouped together, and accessible to be claimed and reviewed by an Approver.

The process continues with the Approver reviewing the submission, which in this case is the image file and the submission form that the partner completed and submitted. The Approver is a user from the brand owner with assigned approval rights, which means this individual has been granted authority to reject or approve submissions. Not all Reviewers-users from the owner who have review rights-have approve rights. Review and approve rights are assigned as separate rights.

To claim and review a submission the Approver downloads the owner Approvals module home page 2500 and then activates the submission link 2504. This causes a submission page 2800 (see FIG. 28) to be displayed. The submission page 2800 includes a pending link 2802, a review link 2804, and an approve link 2806. To retrieve and claim a new submission (i.e., a “pending submission”), the Approver selects the pending link 2802. This causes a pending page 2900 (see FIG. 29) to be displayed. Pending page 2900 includes a table 2902 that lists the submissions that exist in the pending state (regardless of stage). These submission have not been claimed for review.

To claim one of the pending submissions, an Approver clicks the tracking number associated with one of the pending submissions. This causes a review page 3000 (see FIG. 30) to be displayed. The review page 3000 provides a view of the submission selected by the Approver. More specifically, the review page 3000 shows a thumbnail image 3002 of any submitted image file and hypertext links 3004 and 3006 to that image file and to the submission form. Clicking the link 3004 to the image file displays a full size view of the image. Similarly, clicking the link 3006 to the submission form displays a full size view of the submission form. The review page also includes: tracking information 3008, optional comments made with each step in the submission 3010; and an indication of which stage the submission is in 3012.

The Approver reviews the data on the review page 3000, and then clicks the hypertext links 3002-3004 to the image and document attachments, to determine if the submission is one to be claimed for review and edit. If the Approver decides to claims the submission, the Approver clicks an edit button 3030 to open an edit page 3100 (see FIG. 31). The Approver then saves the image and submission form to local storage on the owner workstation 120.

The Approver may use the Adobe Acrobat annotation features to add pertinent information to the submission form (completed template). Image files must be edited in a suitable graphics software package, and likewise saved locally. If the Approver annotates or makes changes to the submission form or the submitted image, the Approver now has updated items and they must be updated in the same manner the partner uploaded the original items.

The Approver now uses the edit page 3100 to: (a) enter partner-specific tracking details into the tracking area 3102 of the edit page 3100 (e.g., the likely product category of the concept and the partner's own ID tracking number); (b) upload the updated submission form and/or image file to the server application 145; (c) enter comments into the comment box 3104 concerning the review in general, or about the specific information on the submission form or image file; and (d) specify one or more Reviewers to which the submission will be routed for review (to specify the Reviewers to which the submission will be routed, the Approver selects the route to Reviewer button 3106; this causes a list of the eligible Reviewers to be displayed and the Approver selects the desired Reviewers from this list.).

After performing the above steps, the Approver opens the state drop-down list 3108 and changes the state to “in review”. Lastly, the Approver clicks commit button 3110 to upload the updated submission to the server application 145, and to route the submission to the specified Reviewers.

At this point, the server application 145 automatically generates an e-mail notification to the specified Reviewers, announcing that the Approver has processed the initial submission. The e-mail (not shown) includes a hypertext link that when selected by the Reviewer will bring the Reviewer directly to the review page 3000, where the submission data and attachments may be viewed by the Reviewer. No e-mail is sent to the partner at this point because the submission is still in review and has not been passed to the next stage. When the submission has been sent to the next stage, the partner receives an e-mail notification.

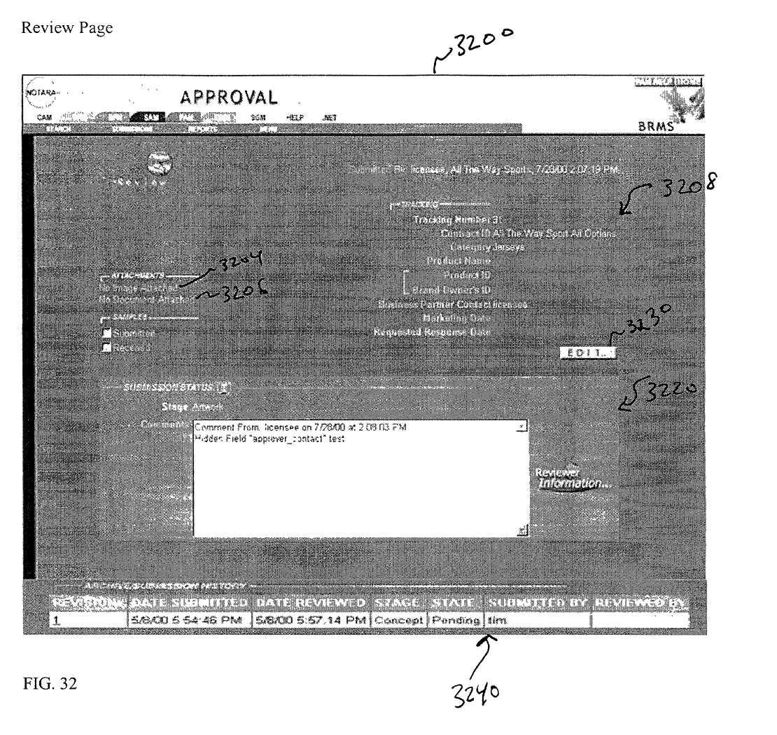

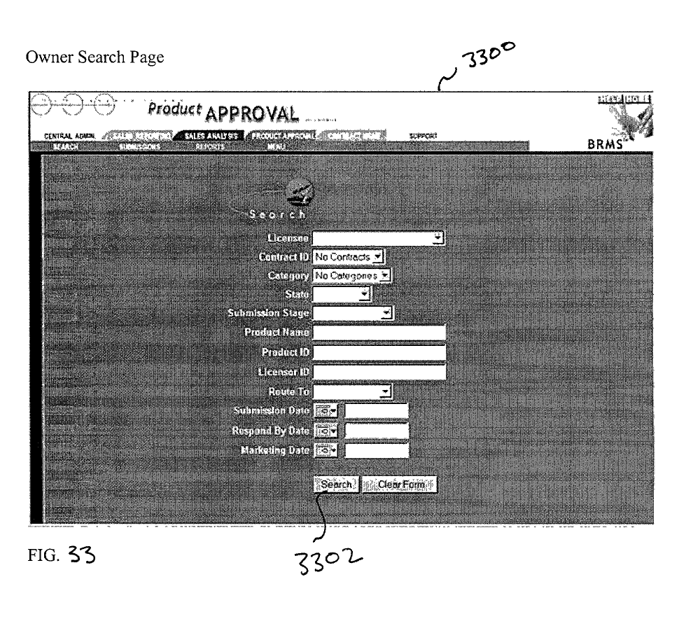

When the Reviewer receives an e-mail notification regarding the submission, the Reviewer clicks an hypertext link included therein. This causes the review page 3200 (see FIG. 32) to be displayed in the Reviewer's browser. The tracking data area 3208 of the review page 3200 has the data added by the Approver, and the submission form also includes the Approver's edits, additions, and markups as made with the Adobe Acrobat® software. The Reviewer can access the submission for by selecting link 3206.

The submission status/comment area 3220 shows the comments made with each step in the submission by the Approver and also shows the Reviewer the current stage of the submission. The comments may provide the Reviewer with instructions or questions from the Approver or partner.

The archive/submission history area 3240 will include a single entry at this point. The entry reflects the Approver's initial review of the submission. As the submission moves through the review process, the archive/submission history table gains additional entries for each time the submission is reviewed and acted upon. The entries in the archive/submission history include a hypertext link that opens the Review page of the submission, as it was at that point in the process.

The Reviewer examines the data on the review page 3200, and then clicks the hypertext links 3204/3206 to the image and document attachments, to determine if the submission meets the criteria for an acceptable submission. The Reviewer does not add information to the submission form document, or edit the image file, because the Reviewer does not have the capability to upload a different version of the submission to the process.

Next the Reviewer clicks edit button 3230 to display the edit page 3100. The Reviewer can click the add comments button 3150 to open the add comment window (not shown). The add comments window provides a means for the Reviewer to add his or her comments to the submission. These comments will appear in the comments box 3104. Next, the Reviewer indicates an official opinion on the submission, by clicking one of the three available radio buttons 3112: approved, re-submit, or reject. Lastly, the Reviewer clicks commit button 3110 to upload the submission to the server, along with the added comments and opinion.

At this point, the server application 145 automatically generates an e-mail notification to the Approver, announcing that the Reviewer has reviewed the submission. That e-mail contains a hypertext link that will bring the Approver directly to the review page 3200. Again, no e-mail is sent to the partner at this point, because the submission is still in review and has not been approved at this stage.

When the Approver receives the e-mail notification, he or she can click the hypertext link included therein. This causes the review page 3200 to be displayed in read-only mode. The page 3200 will display the comments from the Reviewer in the submission status/comment area 3220. The Approver will act on the comments made by the Reviewer, which in this workflow example, says it is OK to approve the submission at this stage, and pass it along to the next. The Approver may examine the data on the review page, and click the hypertext links 3204 and 3206 to the image and document attachments, to confirm that the submission is ready to approve at this stage.

Next, the Approver clicks edit button 3230 to move to the edit page 3100. At this point the Approver can choose to repeat the review process by routing the submission to another Reviewer, using the route to Reviewer button 3106, or the Approver can elect to move the submission forward through the submission and review process by assigning an owner id (optional) and changing the state and next stage fields in the submission status are. For this sample workflow, the Approver will move the submission forward. That is, the Approver enters a unique owner ID number for the submission (optional), opens state drop-down list 3108 and selects “stage approved” from the list, and opens stage drop-down list 3111 and selects the next stage (e.g., “pre-production”). The Approver has the discretion to move the submission on to any stage in the sequence, and need not move in sequence from one to the next. (Keep in mind that these stages can be defined by the owner to meet specific review and approval processing requirements.) The Approver can enter comments to provide the partner with feedback, instructions, or questions on the submission, and on the requirements for the next stage in the process. Lastly, the Approver clicks commit button 3110 to upload the data to the server application 145.

At this point, the server application 145 determines that the submission has been “stage approved” and automatically generates an e-mail notification to the partner, announcing that the submission has been reviewed and approved at the current stage, and moved on to another stage. The e-mail contains a hypertext link that will bring the Reviewer directly to the submission review page 3200, where the partner can view the comments made by the Approver, and also examine the updated submission form and image file.

The process continues with the partner reviewing the submission, which now contains the commented feedback from the Reviewer and the Approver, and the updated image and submission form. The submission has now changed state, from “in review” to “pass.” This bumps the stage to the Approver's choice, in this case pre-production sample. The Approver included instructions for the partner in the comments area 3104 of the edit page 3100.

At this point the partner receives the e-mail notification announcing that the submission has moved along in the review process. The e-mail includes the hypertext link to the review page 3200, where the partner can examine the Approver and Reviewer comments, and also look at the image file and submission form attachments. At this juncture, the partner can continue the submission process as may be necessary.

If another stage is required before final pass and approval, the partner may save a copy of the submission form if it will need updating. Also, the partner may obtain a newer version of the image file, which has been revised based on the specific instructions provided by the Approver or Reviewer. This newer image file will be stored locally with the updated submission form, and then submitted again as the review process continues.

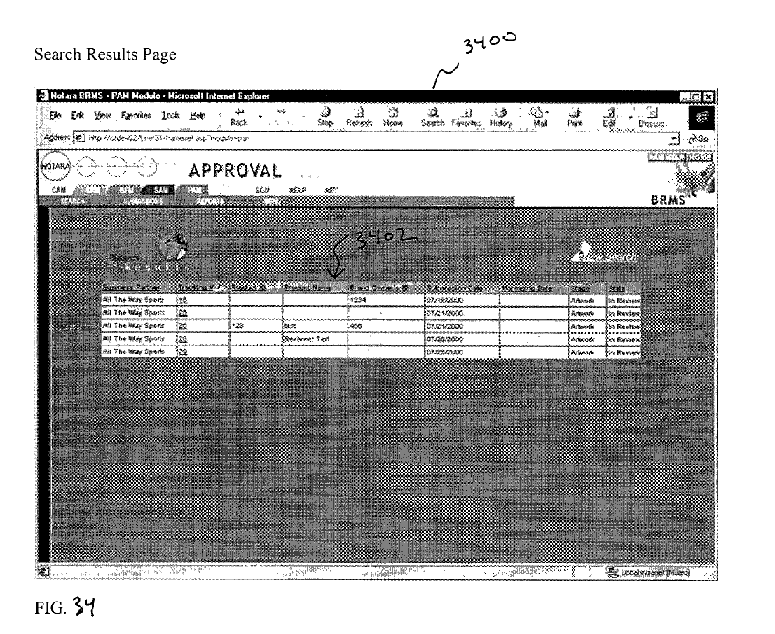

It should be noted that as an alternative to using the hyperlink in the e-mail notification, a partner can also select the search link 2606 from the partner approval home page 2600 to locate a submission. Upon selecting the search link 2606 a search page 3300 (see FIG. 33) is displayed. The partner enters the search criteria into the search page 3300 and activates search button 3302. The results of the search are displayed in the search results page 3400 (see FIG. 34). The search results page 3400 provides a list 3402 of the submission that matched the search criteria. By selecting one of the submission in the list, the review page 3200 is displayed for the selected submission.

Sales Reporting (SR) module 274

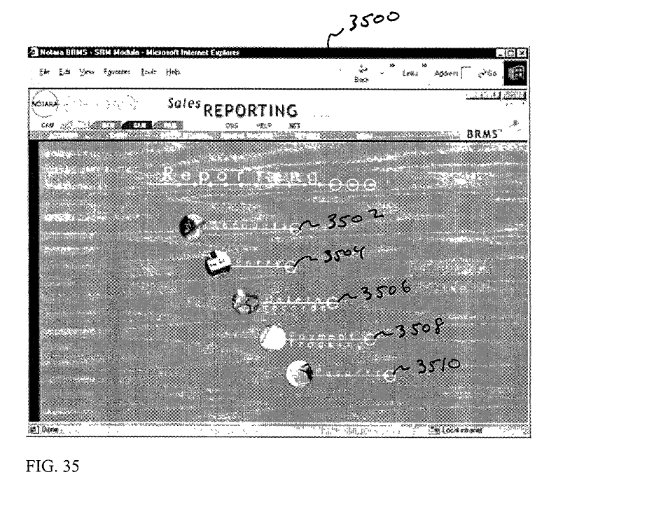

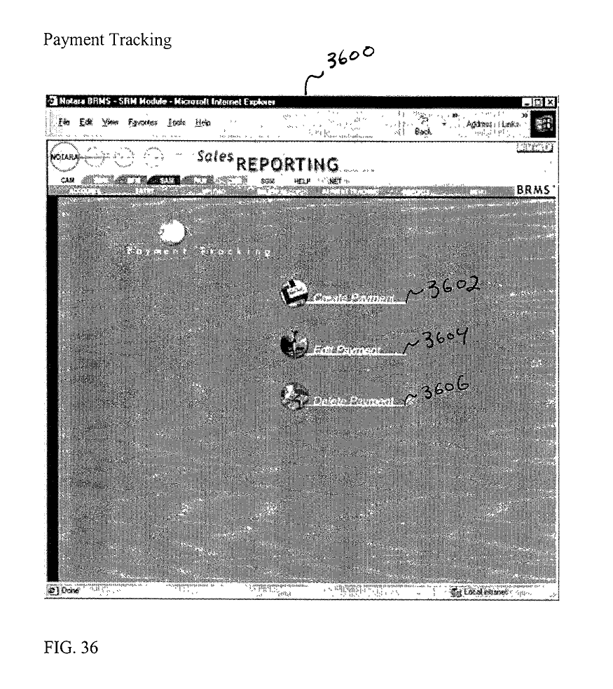

The Sales Reporting (SR) module 274 is used by both owners and partners. Partners use this module to submit their sales data, in accordance with their respective contract terms. Owners use the module to create and edit sales accounts and to enter and track royalty payments received from partners. Both owner and partner use the module to run and review reports. These tasks are available from a sales reporting home page 3500 (see FIG. 35). That is, sales reporting home page 3500 includes link 3502-3510 for accessing the following tasks (sub-modules) respectively: accounts, entry/upload, delete records, payment tracking, and reports.

The Accounts Sub-Module/Task:

Only owners can access this task. The accounts task enables an owner to create and edit partner sales accounts. These accounts represent the vehicle through which partners will report sales data for the products covered under the contract agreement with the owner. The account information includes an account name and number, location information, and a partner contact name, who is an individual that the owner may contact regarding this account.

The Entry/Upload Sub-Module/Task:

There are two ways in which a partner can report sales data. One is a data entry mode and the other is a file upload mode. In the data entry mode, the partner enters sales data into an on-line form which is then submitted to the server application 145. The server application 145 captures the data and stores it in an owners sales database (not shown).

In the file upload mode, the partner creates either an XML (extensible mark-up language) file or a CSV (comma-separated value) file that contains the sales information and then uploads the file to the server.

With both the date entry and upload mode, the reported sales figures are captured at the server application 145 and placed into the owner sales database and used to calculate the appropriate amount of royalty due, based on the specifics of the licensing agreement for which the sales are being reported. The data captured to the owner sales database can be automatically exported to general business applications in the form of custom sales reports.

The delete records sub-module/task: This task enables owner and partner to delete sales data from the owner sales database.

The Payment Tracking sub-module/task:

The Payment Tracking sub-module provides owners with centralized access to royalty payment history. The Payment Tracking task allows owners to create and maintain records of royalty payments received from their partners. They can also record payments they have issued to partners, for example, to correct an overpayment. They can optionally create payment allocation records for each payment by applying some or all of the payment dollars received to one or more contracts, and reporting periods. This flexible function also allows owners to allocate more than one payment received to the same contract, and reporting period. This additional level of detail can help facilitate communication with partners, and is available for online review, and reporting. Comments can be entered for each payment, and for each payment allocation, for example, to record special terms or contact information. Owners can also assign a unique transaction identifier to each payment, and payment allocation.

To access the payment tracking sub-module, the user activates the payment tracking link 3508 that is displayed on the sales reporting home page 3500. Upon selecting the payment tracking link 3508, a payment tracking home page 3600 is displayed. The payment tracking home page 3600 includes a create payment link 3602, an edit payment link 3604, and a delete payment link 3606.

The create payment link is selected 3602 when the owner wants to manually record a new royalty payment received from a partner or record a payment the owner has made to a partner, for example, to correct an overpayment. The edit payment link 3604 is selected when the owner wants to modify an existing payment record, and optionally allocate a portion or all of the payment dollars received to specific contracts, and reporting periods. The delete payment link 3606 is selected when the owner wants to delete a selected payment record, and all allocations associated with the payment.

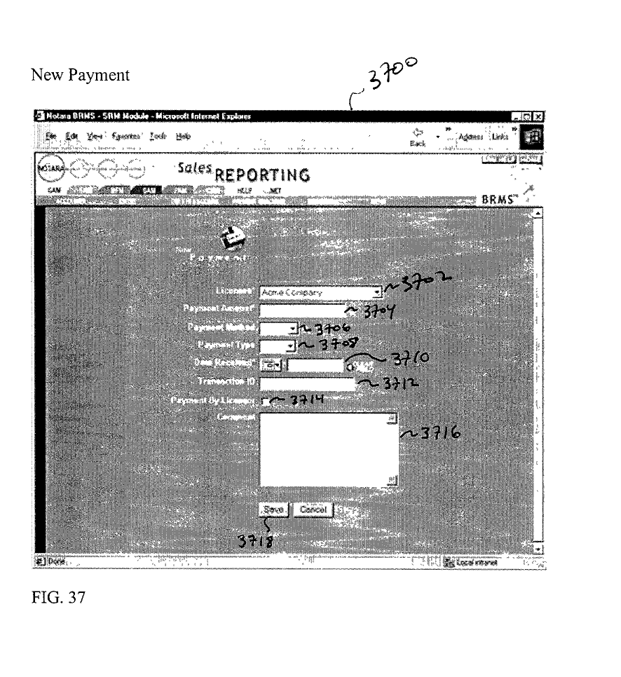

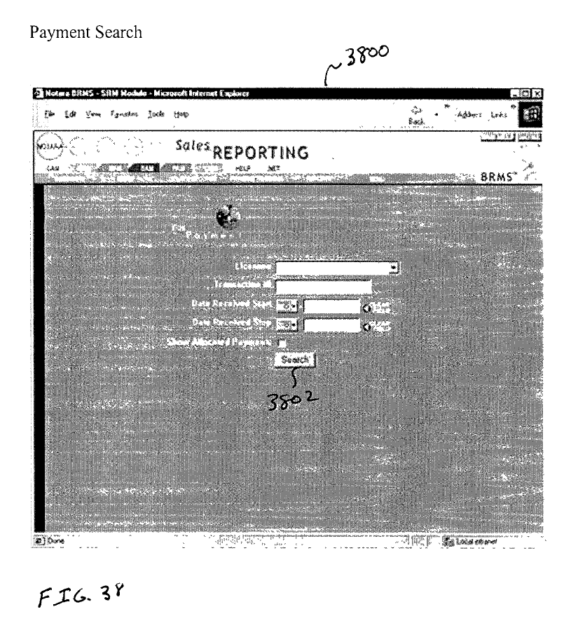

When a the create payment link 3602 is selected, a new payment page 3700 (see FIG. 37) is displayed. Page 3700 includes Partner drop-down list for selecting a partner to associate with the new payment record being created. It also includes the following: a Payment Amount field 3704 for entering the total amount received from the partner; a Payment Method drop-down list 3706 for selecting the method in which the payment was made (e.g., cash, check, etc.); a Payment Type drop-down list 3708 for selecting a payment type; a Date Received field for inputting the date on which the payment was received; a Transaction ID field 3712 for entering up to 20 free-form characters to uniquely identify the payment received (this field is commonly used to record the check number, EFT number, partner account number, or the transaction number from the brand owner's accounts receivable system); a Payment by Licensor checkbox 3714 that should be selected only when the payment record being created is for recording a payment that was made to the partner; and a Comment text box 3716 for entering free-form text regarding the payment, for example, details of special terms, or contact information.

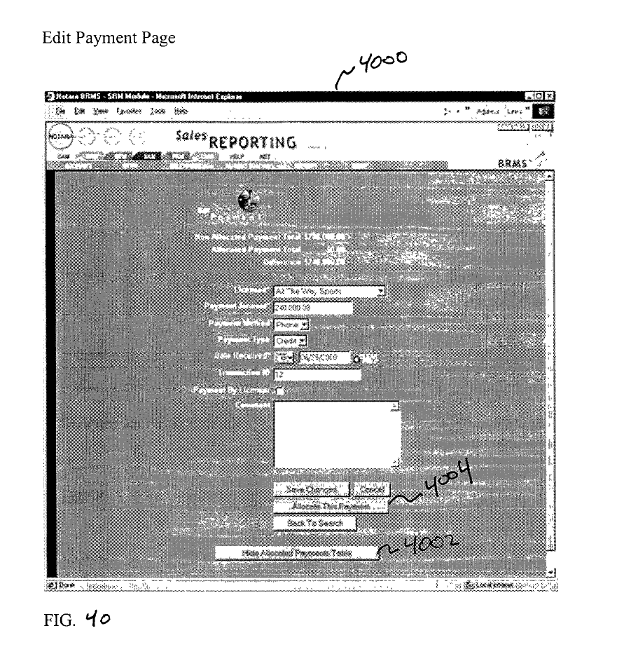

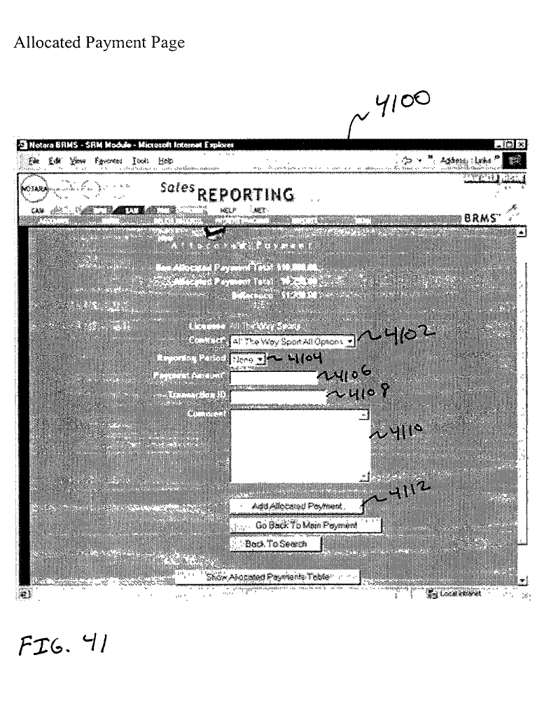

After all of the data has been correctly entered into the new payment record page 3700, the user activates the save button 3718. This causes an Edit Payment page 4000 (FIG. 40) to be automatically displayed. Edit payment page 4000 lists the new payment information. This transition to the Edit Payment page 4000 allows the owner to allocate a portion or all of the payment dollars received to specific contracts, and reporting periods. The edit payment page is discussed in more detail further below.

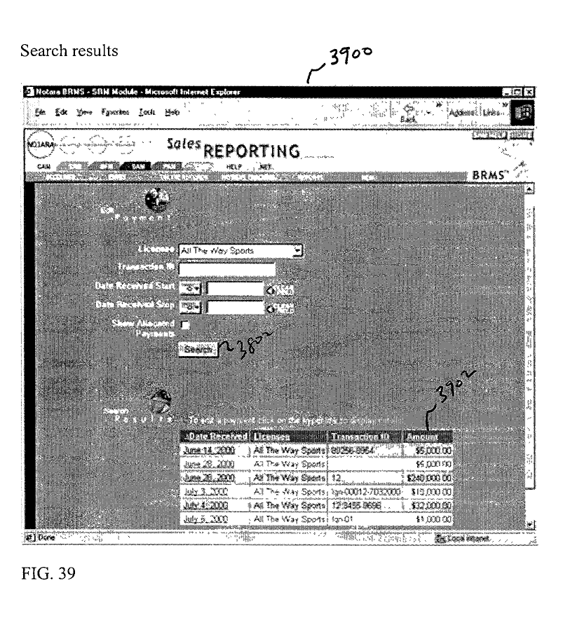

When a the edit payment link 3604 is selected, a payment record search page 3800 (see FIG. 38) is displayed. The search page 3800 allows the owner to input search criteria (e.g., partner name, transaction ID, etc.) for finding certain payment records. After the owner enters his or her search criteria and activates the search button 3802, a search results page 3900 (see FIG. 39) is displayed. Search results page 3900 includes a list 3902 of the payment records that match the inputted search criteria. Upon selecting one of the payment records from the list 3902, the edit payment record page 4000 is displayed for the selected payment record.

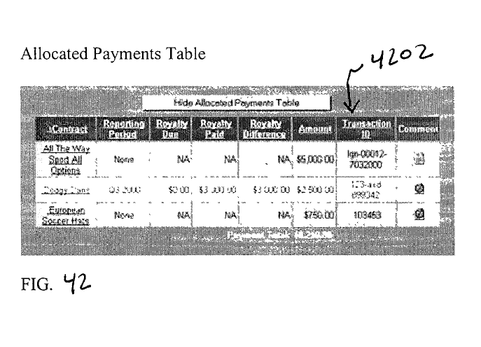

The edit payment record page 4000 is used to modify existing partner payment records. This page can also be used for displaying an allocate payment page 4100 (see FIG. 41). The allocate payment page 4100 is used to allocate payments to selected contracts and reporting periods, as described further below. An allocated payments table 4202 (see FIG. 42) can be displayed at the bottom of the edit payment page 4000 by activating the show allocated payments button 4002. The allocated payments table 4202 provides a summarized view of all existing allocations for the selected payment, and includes columns that track the variance between royalty dollars due and received.

An owner can optionally create payment allocation records for each payment received by a partner. That is, the owner can apply some or all of the payment dollars received to one or more contracts and reporting periods. This flexible function also allows the owner to allocate more than one payment received to the same contract and reporting period. This additional level of detail can help facilitate communication with partners, and is available for online review, and reporting. To create the payment allocation records, the owner activates an allocate payment button 4004 that is displayed on the edit payment record page 4000.

Activating the allocate payment button 4004 causes the allocated payment page 4100 to be displayed. From this page, the owner can allocate portions of a payment to a particular contract and reporting period. The page 4100 includes a contract drop-down list 4102 for selecting a contract to which a portion of a payment or a total payment will be allocated. Page 4100 also includes: a Reporting Period drop-down list 4104 for selecting a reporting period; a Payment Amount field 4106 for entering the total amount of payment dollars to allocate to the selected contract and reporting period; a Transaction ID field 4108 for entering a unique identifier that identifies the payment allocation; and a Comment text box 4110 for entering free-form text regarding the payment allocation.

When the owner is ready to allocate the payment or portion thereof, the owner activates the Add Allocated Payment button 4112. If the Allocated Payments Table 4202 is visible at the bottom of the page 4100, the new allocated payment record appears in the table 4202. The Non-Allocated Payment Total, Allocated Payment Total, and Difference fields, located in the top of the Allocated page 4100, are automatically updated. To create another allocation record for the selected payment, the owner fills out the information requested on the page 4100 and again activates the add allocated payment button 4112.

The Reports sub-module/task:

This task enables partners and owners to select, generate, and display an available report. These are pre-defined reports that provide detailed information regarding partner sales figures. The user can set the specific reporting timeframes, and also select any of three presentation formats: HTML, ActiveX, or Java.

Budgeting and Forecast (BF) Module 276

The Budgeting & Forecast (BF) Module 276 provides a collaborative, online forum for creating and monitoring royalty budgets and forecasts. The BF module 276 makes it easy to set up, and maintain a budget table, monitor performance, run comparison reports, and populate budget tables. A complete history of budget data, and actual sales is stored in BRMS 110. The BF module 276 also includes communication features that provide the ability to enter and view notes and send automatic e-mail notification to partners when notes are added to a budget category (i.e., budget column) or the budget status is changed.

The BF module 276 can be configured to meet most any unique budgetary requirements. During system configuration, an owner defines a budget table. That is, the owner defines a number of budget categories (also referred to as columns) used to enter data and defines labels for each column to indicate the nature of the information (for example, Baseline Budget, Stretch Budget, Partner Forecast, Owner Forecast, etc.).

A “calculated” category feature, available during system configuration, lets an owner define a formula using data in one or two budget categories and display the results. For example, an owner could create a calculated category labeled “Partner Variance %” to display the variance between a partner forecast budget category and actual budget data category as a percentage. Calculated categories are automatically updated for a specific budget when budget data is saved, and for all budgets, when the Budgeting & Forecast OLAP database 258 is refreshed.

The BF module 276 enables users to: collaboratively develop budgets, based on individual contracts, and contract terms; add notes to a selected budget category (i.e., column) and view a summary of all notes previously entered; edit selected columns; “lock” budgets by contract, fiscal year, and budget category, preventing numbers in a selected column from being edited, or “unlock” the column to allow editing; trigger automatic e-mail notification to selected individuals whenever a budget category is locked, unlocked, or when notes are added; review historical budget, forecast, and performance data, and optionally use the data to create new budgets and forecasts; edit historical data (data from a prior or current fiscal reporting period); generate online and printed budget reports for selected contracts; and extract budget/forecast/actual data from the Budgeting & Forecast OLAP data cube 258, and import the data into an MS Excel(R) spreadsheet.

The BF module 276 offers an extremely high degree of customization. During BRMS 110 configuration, an owner defines a budget level, budget categories, and special “calculated” category formulas.

Budget Level: When the BF module 276 is configured, a subset of the data tree's levels and nodes associated with contracts are selected for budgeting. The BF module 276 is custom-designed by the owner to require budget numbers for some or all of the following dimensions that are defined within BRMS 119: product, territory, distribution, and user-defined trees (UDT1, UDT2, and UDT3). This flexibility allows the owner to create targeted budgets and forecasts.

Budget Category: All budget categories available for entry and reporting in the BF module 276 are defined at configuration time. That is, an owner defines the number of columns used to track budget and forecast data, assigns a name to each column, and indicates which columns are accessible to owner users and which are accessible to partner users.

Calculated Category: The “calculated” category feature allows the owner to define a calculation (formula) using data in one or two budget categories. The result of the calculation are displayed in a column. For example, the owner could create a calculated category labeled “Partner Variance %” to display the variance between a partner forecast and actual budget data as a percentage. Calculated categories are automatically updated when budget data is saved, and when the Budgeting & Forecast OLAP database is refreshed.

Security Keys: Unique security keys are associated with most tasks and functions within the BF module 276. This allows BRMS administrator to customize access for each BRMS user. In addition to limiting access at the module, and task level, security is provided at the budget category level. That is, for each user-defined budget category, separate security keys are required to: view the budget category; enter/edit data for future reporting periods; edit historical data (past and current reporting periods); lock the budget category; unlock the budget category; enter notes, and view previously entered notes. Thus, if a particular BRMS user does not have the appropriate key, the user would not be able to perform the above listed functions.

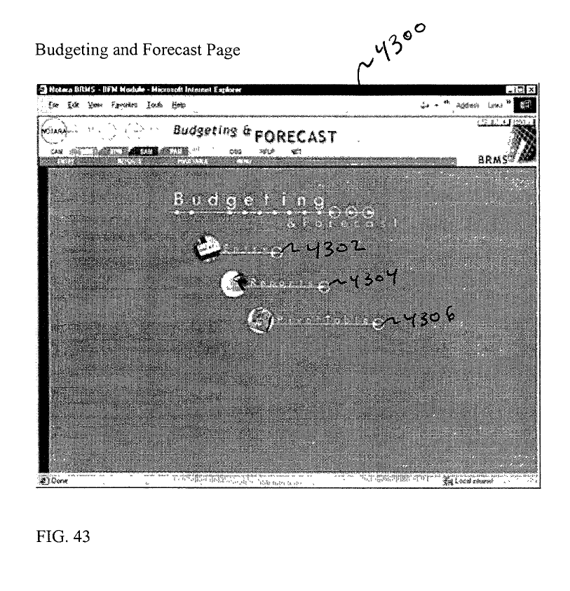

FIG. 43 illustrates a home page 4300 for the BF module. The home page 4300 includes a link 4302 for accessing an entry task, a link 4304 for accessing a reports task, and a link 4304 for accessing a pivot-table task.

The entry task is used to perform a number of budgetary functions. For example, the task is used to: select a contract and view a budget table associated with the contract; manually enter budget numbers into the budget table; copy numbers from a category in a prior or current budget and fiscal year to a category in the budget table currently being edited; edit a selected budget category (for example, modify forecast numbers to reflect current market conditions); “lock” a budget category to prevent numbers in the selected column from being edited or “unlock” to allow editing; trigger automatic e-mail notification to the contract billing e-mail address when a budget category is locked, or unlocked (provided Budgeting & Forecast e-mail events are activated by the BRMS System Administrator); add notes to a selected budget category and optionally, send e-mail notification to the contract billing e-mail address; and view a summary of all notes previously entered for a selected budget category.

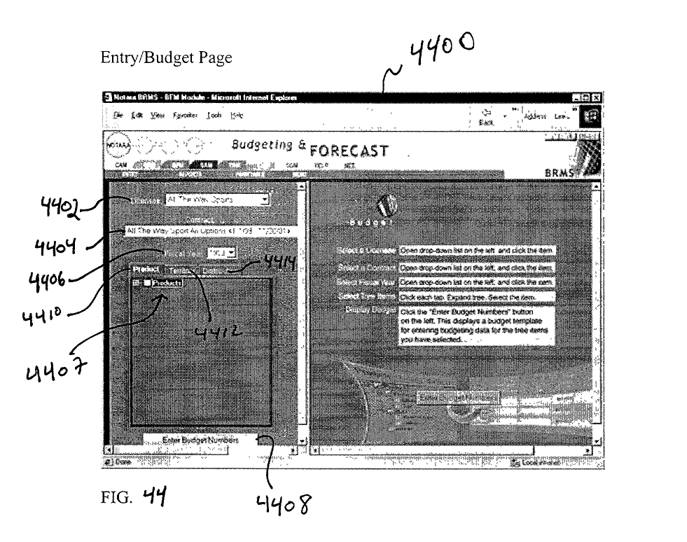

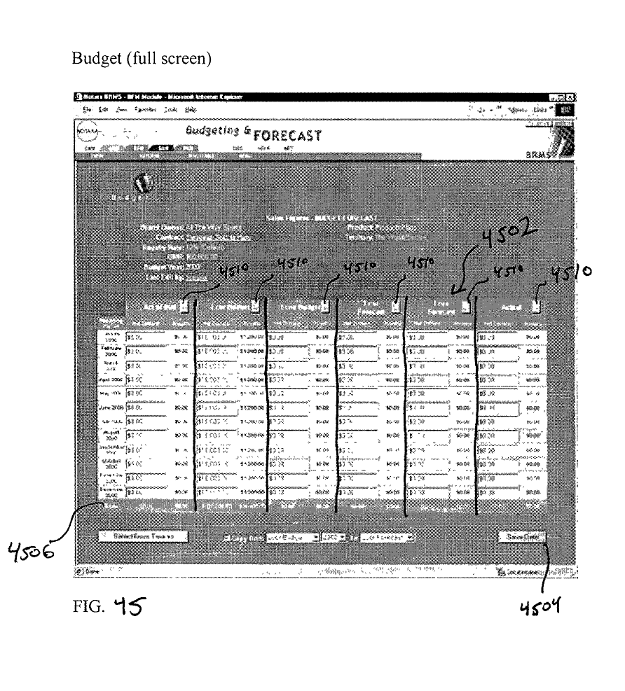

To view a budget table associated with a particular partner, fiscal year, and contract, a user selects the link 4302 associated with the entry task. This causes a budget page 4400 (see FIG. 44) to be displayed to the user. The page 4400 includes: a Partner dropdown list 4402 for selecting the particular partner; a Contract dropdown 4404 for selecting the particular contract; and a Fiscal Year dropdown 4406 for selecting the particular fiscal year. After the partner, contract, and fiscal year have been selected, the user activates a budget numbers button 4408. This causes the budget table 4502 (see FIG. 45) associated with the selected partner, contract, and fiscal year to be displayed, provided that the user has the security key that allows one to view the table. Additionally, the columns of the table 4502 that are visible to the user are only those columns that the user is authorized to see.

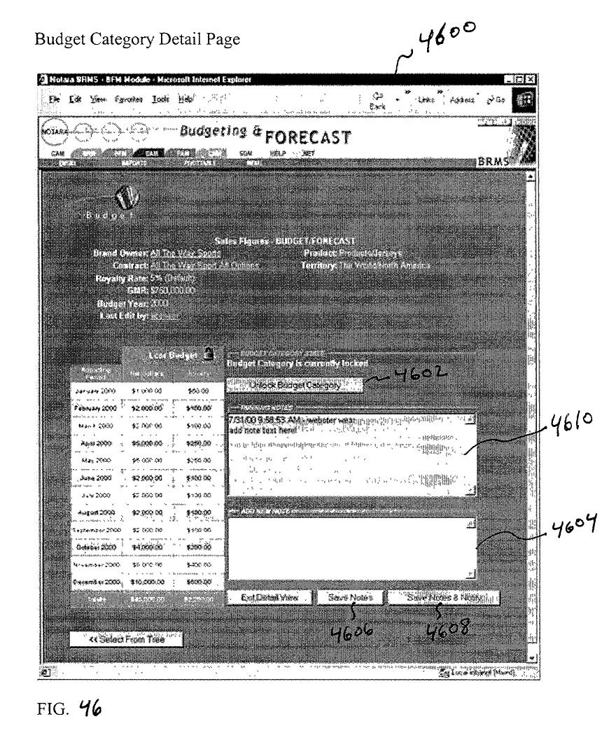

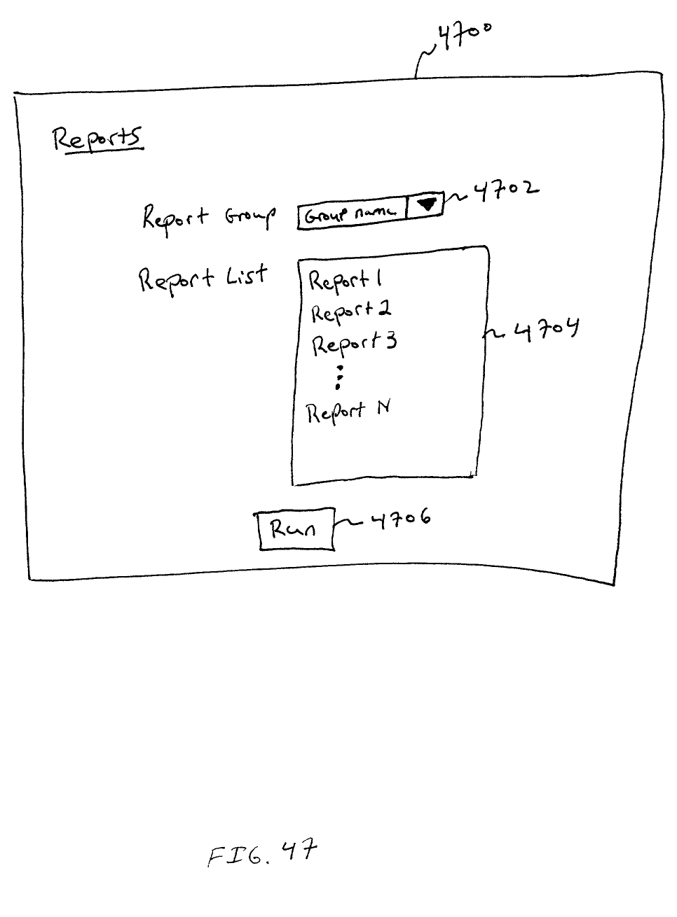

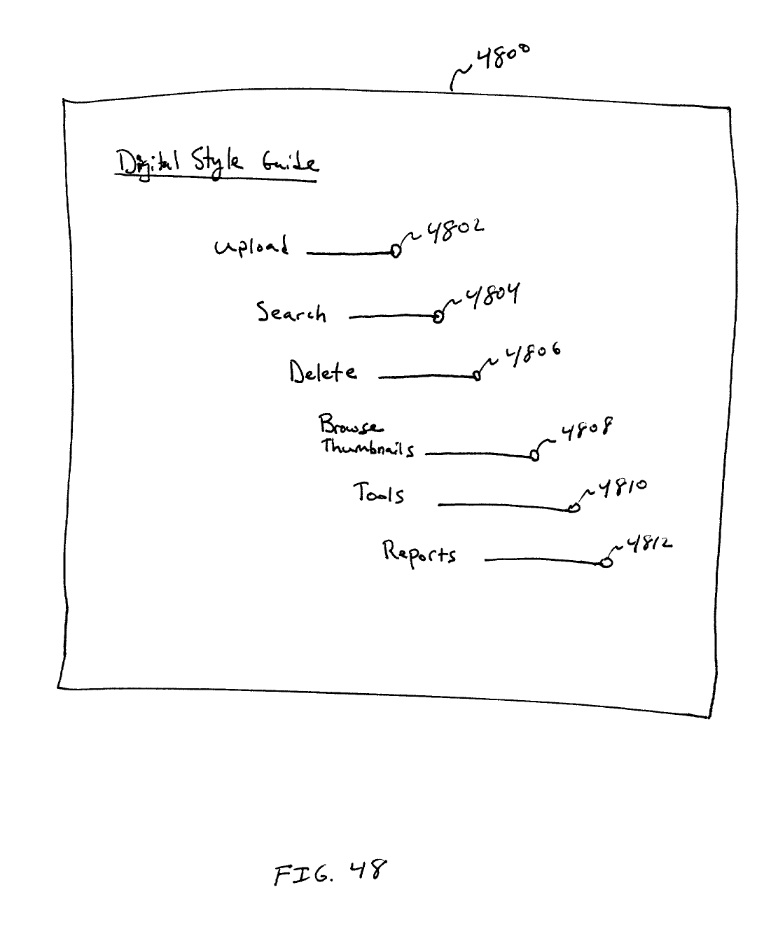

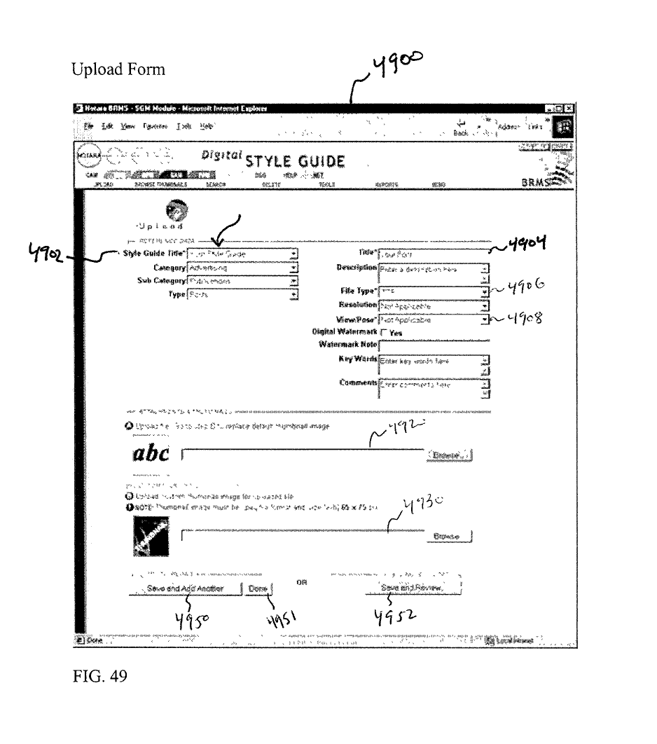

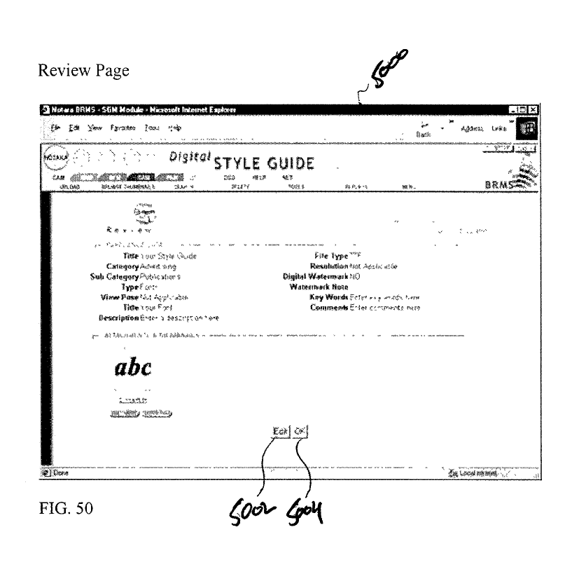

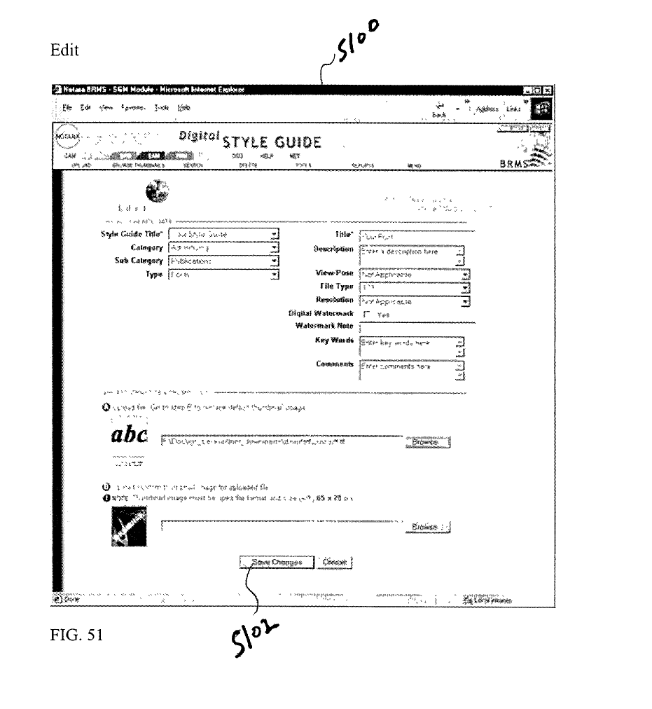

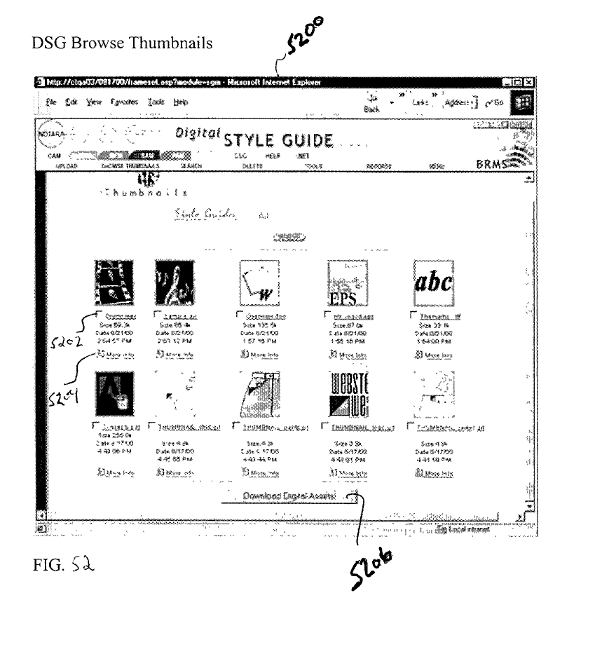

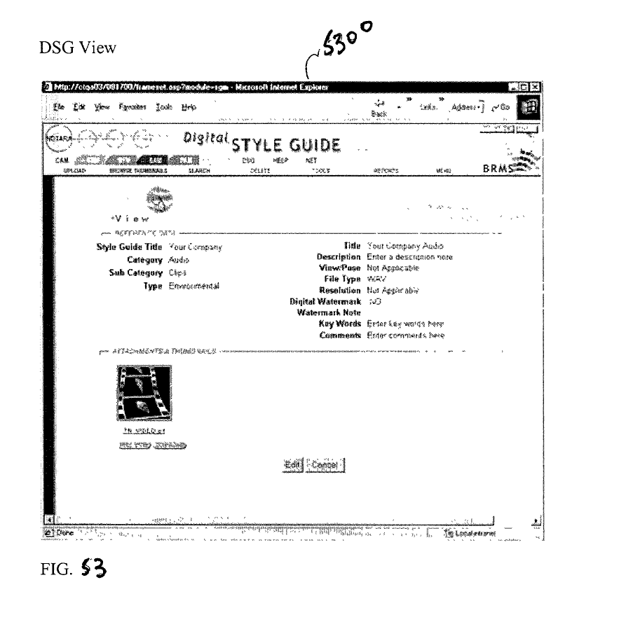

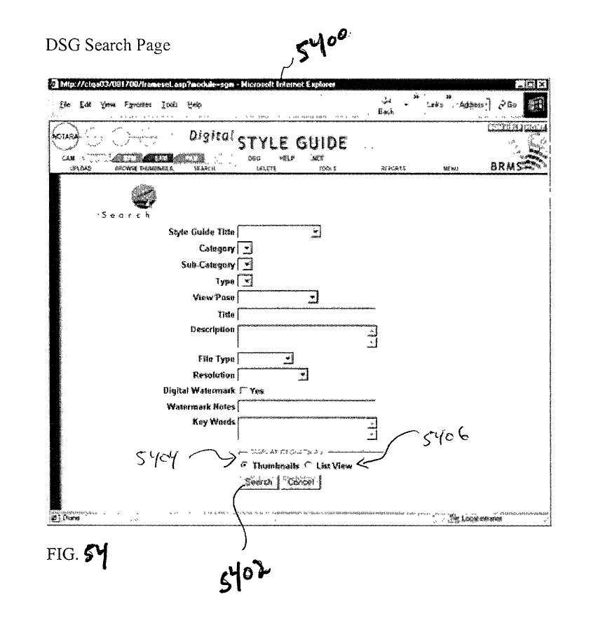

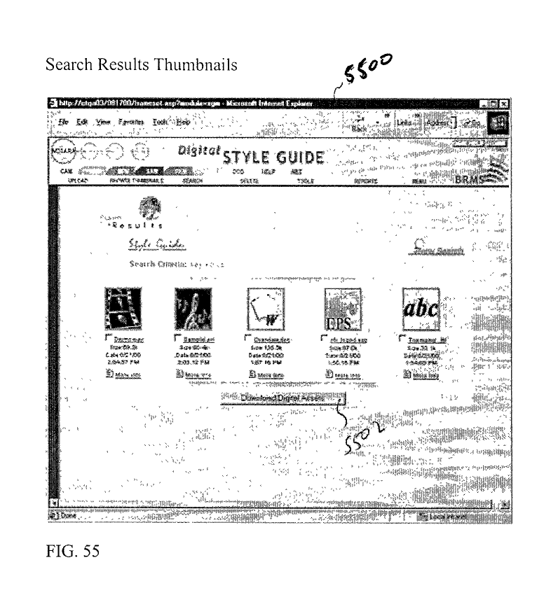

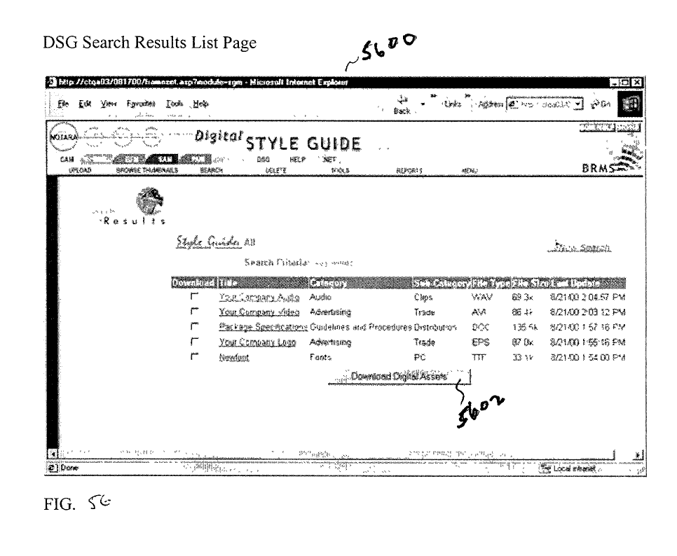

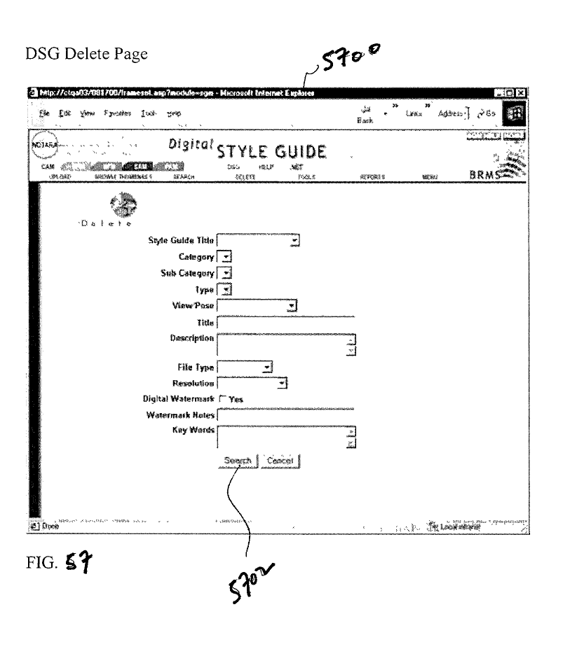

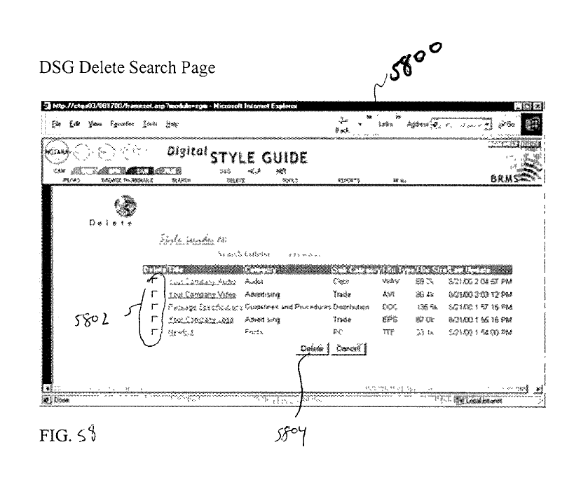

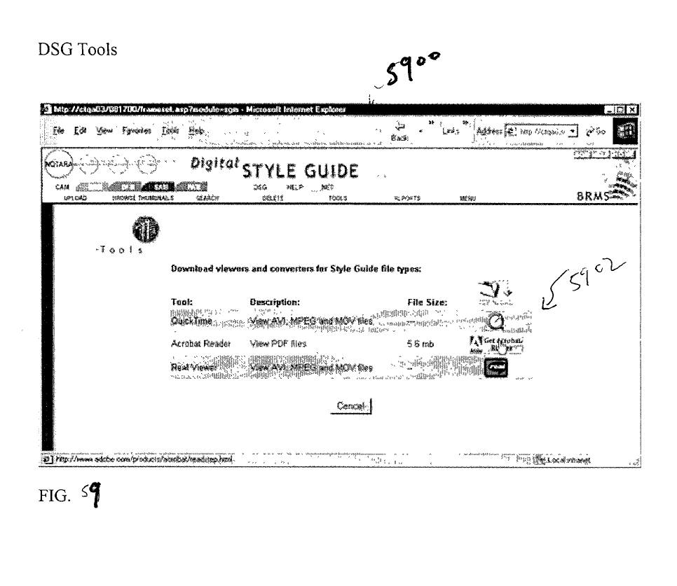

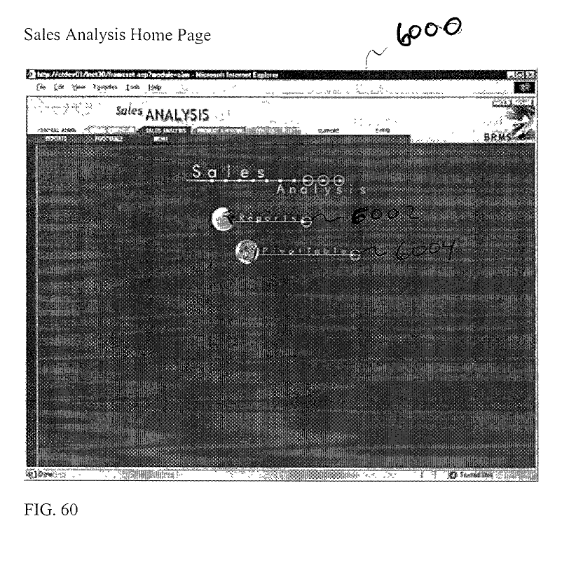

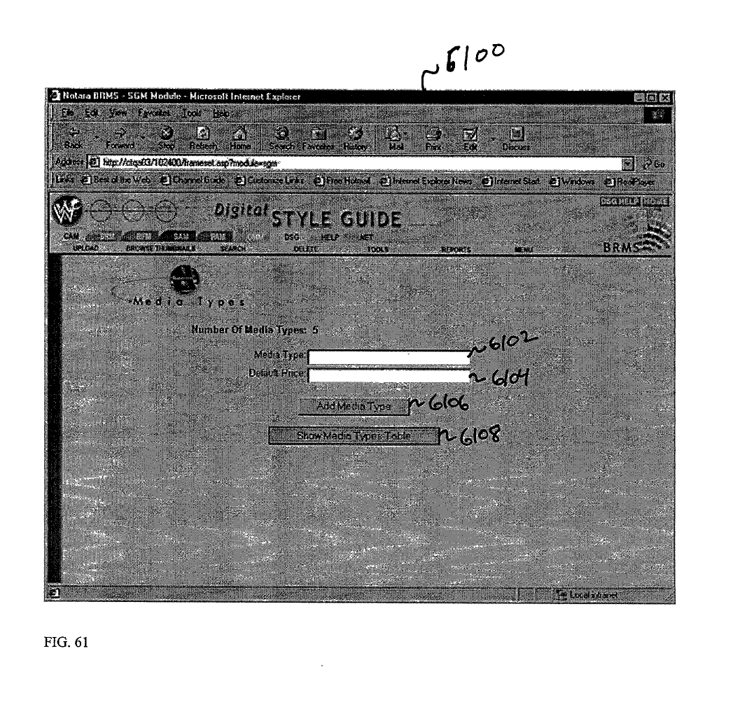

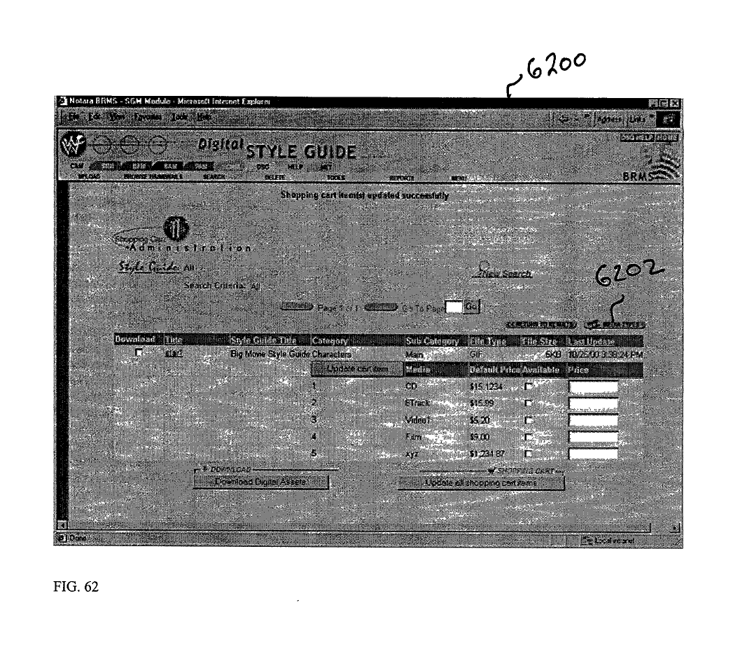

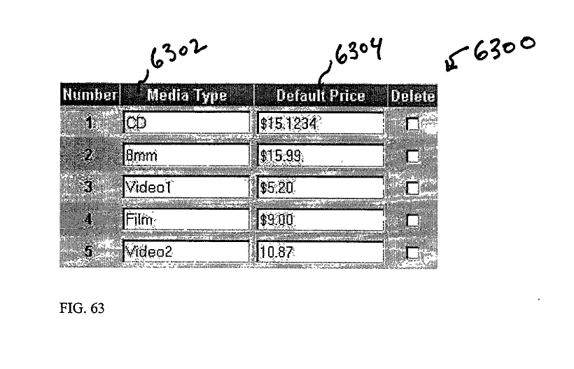

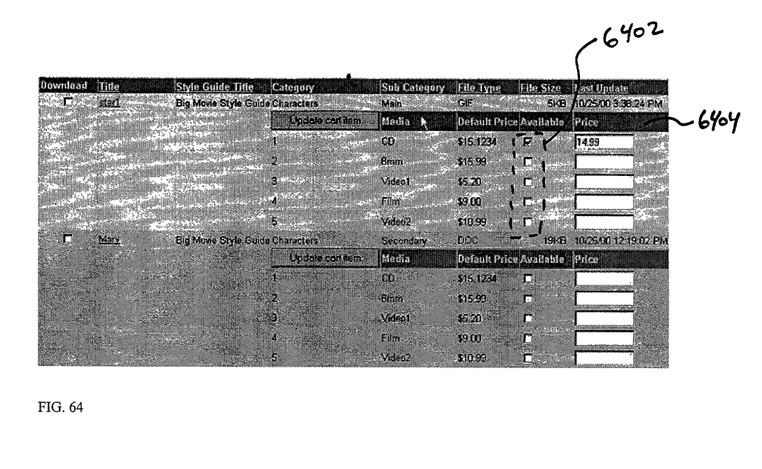

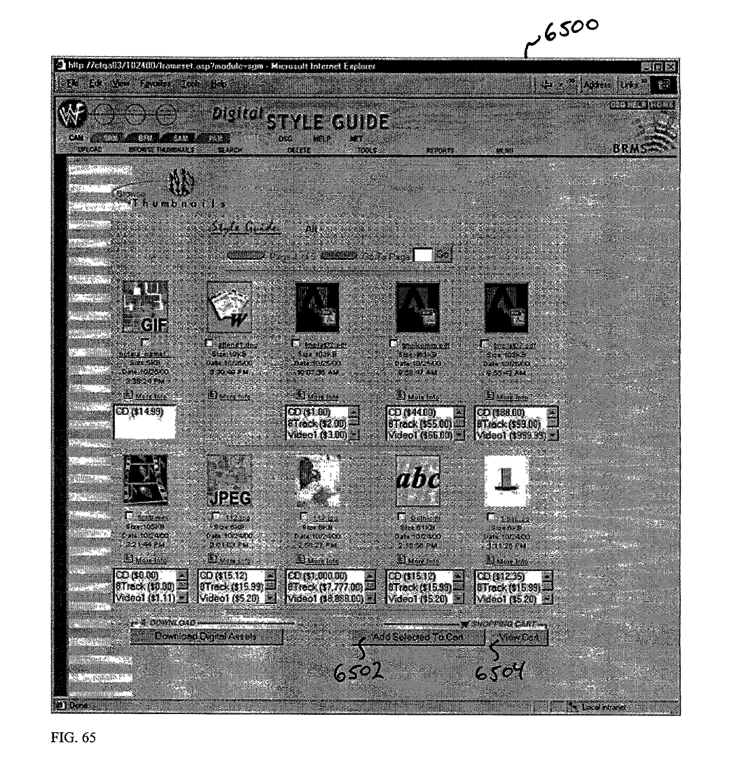

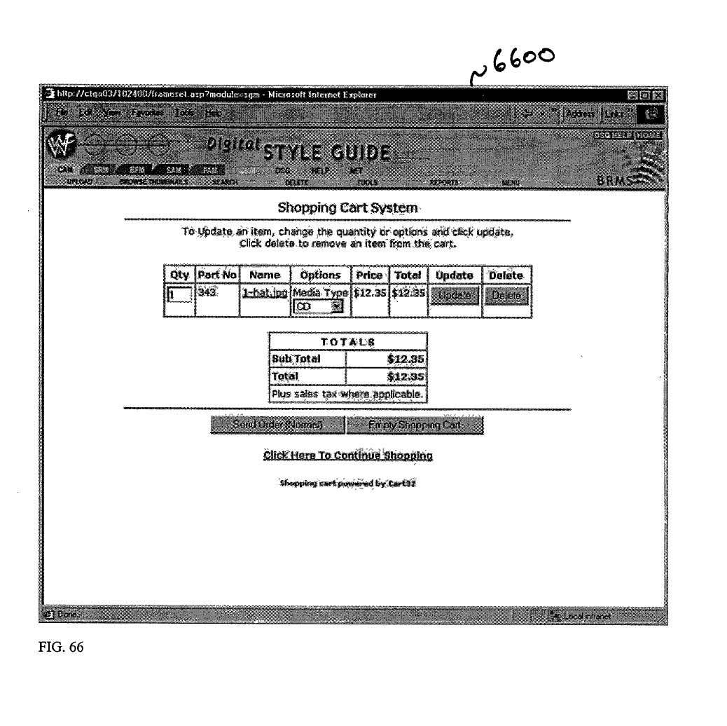

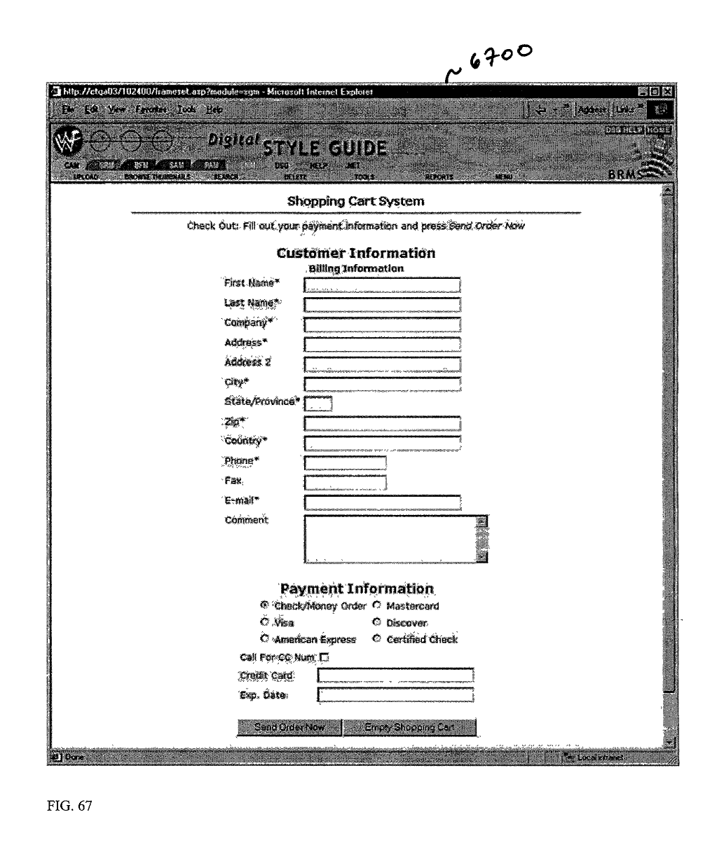

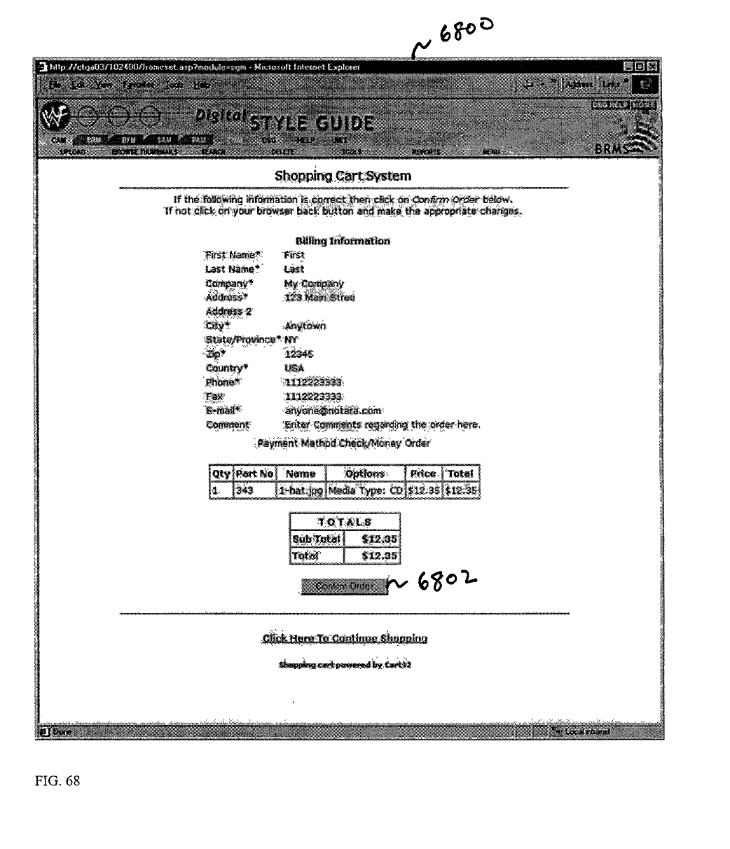

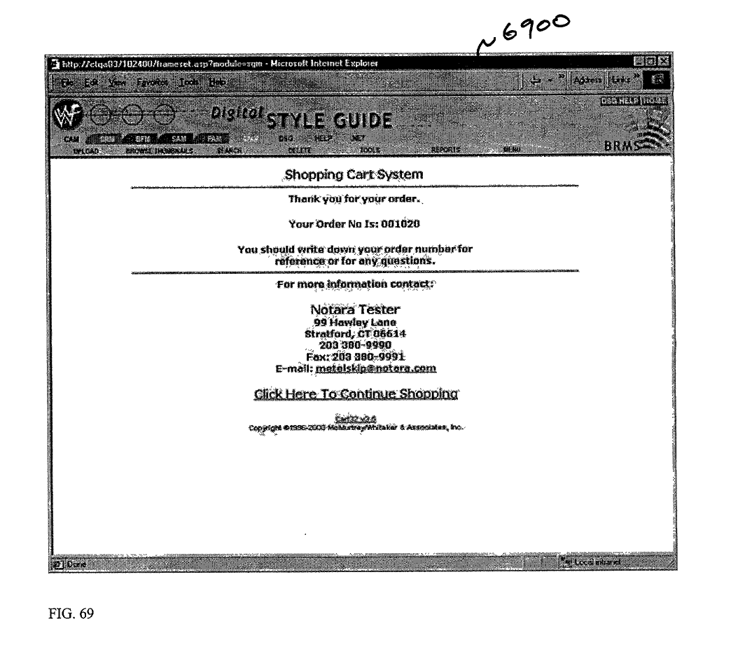

To view a particular column in greater detail, the user simply activates the detail button 4510 that is associated with the column for which the user would like to see more detail. Upon selecting the detail button 4510, a detail budget page 4600 (see FIG. 46) is displayed. The detailed budget page 4600 includes a toggle button 4602 for “locking” and “unlocking” the column displayed in the page 4600. Again, an e-mail notification is sent to a predetermined individual or group whenever a column is locked or unlocked.

The detail budget page 4600 also includes a notes text box 4610 that displays all notes that have been inputted into the system. The page 4600 also has an add new notes text box 4604 for allowing the user to input new notes. After the user types in his or her notes into the add new notes text box 4604, the user can either select the save notes button 4606 or the save notes and notify button 4608. Selecting either button will cause the notes that were input into text box 4604 to show up in text box 4610. However, if the user selects the save notes and notify button 4608, then, in addition to the notes being saved, an e-mail notification is sent to a predetermined address.

Entering Budget Data Into A Table:

To enter or edit budget numbers, a user selects the link 4302 associated with the entry task. This causes the budget page 4400 to be displayed to the user. The user then selects a partner, a contract and a fiscal year. Next, from the contract data tree 4407, the user select one element from each tab 4410, 4412, and 4414, at the lowest level in the tree.

The tabs represent the basis of the selected contract—for example, elements such as products, territories, and distribution channels.

After all contract elements have been selected, the user clicks the Enter Budget Numbers button 4408. This causes the budget table 4502 associated with the selected items to be displayed.

From here, the user can simply enter budget numbers for each reporting period in a budget column of the budget table (for example, Budget Net Dollars/Units). The format of the column—units or dollars—is based on the contract terms. Each row of the table represents a reporting period specified in the contract. Unless the user has the security key that allows him or her to edit historical data, the user can enter budget numbers for only future reporting periods.

After the data is entered into the table, the user clicks the save data button 4504. The Totals row 4506, located at the bottom of the budget table 4502, displays the sum of all budget numbers entered in each column.

Referring back to FIG. 43, a user selects the pivot table link 4306 to access budget/forecast/actual data stored in the Budgeting & Forecast OLAP database or “cube” 258 for online analysis. The user can export data to other business applications, and create, display, and print custom lists or reports. For example, any data displayed in the PivotTable (not shown) can be exported to Excel 2000 as an Excel PivotTable and then displayed as a chart. It can also be saved in HTML, PDF, or in a variety of Excel formats.

Using the PivotTable features requires the installation of Microsoft Office(R) Web Components on the workstation. It should be noted that complete PivotTable functionality is not available in all browsers; it requires Microsoft Internet Explorer 4.x or higher, and Microsoft Office 2000.

If the user's workstation includes Microsoft Office 2000 and Internet Explorer 4.x, the user can use the Pivot Table task to access the Budgeting & Forecast OLAP (online analytical processing) database 258. In an OLAP database, information is viewed conceptually as cubes, which consist of descriptive categories (dimensions) and quantitative values (measures). A multidimensional database makes it easy to formulate complex queries, arrange data on a report, switch from summary to detail data, and filter or “slice” data into meaningful subsets.

Each time a user runs the PivotTable task, it shows the data since the last time the “cube” was refreshed. When the source database changes, or is updated with new information, use the Tools task in the Central Administration module to refresh the cube with the latest information. Typically, the BRMS Administrator schedules the refresh function on a regular basis (for example, nightly) as part of BRMS system maintenance.

The PivotTable is so named because one can dynamically change or pivot the layout to analyze the data in different ways. One can rearrange row headings, column headings, and page fields until the desired layout is achieved. Each time one changes the layout, the PivotTable immediately recalculates the data based on the new arrangement.

The PivotTable has fields that one can drag and drop on the sides of the cube. One can look for specific information, display larger or smaller amounts of detail, or move the rows and columns to different areas to calculate summaries or totals. For example, it can display field values horizontally or vertically, and then calculate the total for the row or column. It can also use field values as row or column headings, calculating individual amounts at the intersection of each row and each column, and then calculating subtotals and grand totals. For example, to analyze sales by product category for each partner, one can list partner names as column headings across the top, product categories as row headings down the side, and the sales amount calculated by product category for each partner at the intersection of row and column.

If a user prefers not to use the PivotTable task or does have Microsoft Office 2000 installed, the user can create and run MDX (multidimensional expression) reports to access the Budgeting & Forecast OLAP database 258. MDX is a highly functional expression syntax for querying an OLAP database. The PivotTable and MDX reports both access the same multidimensional OLAP data. However, before the user can access MDX reports in the BF module 276, the reports must first be created and then, added to BRMS 110 through the Central Administration module, as discussed above.

To run an MDX report in the Budgeting & Forecast module the following steps are performed: (1) from the Budget & Forecasting module home page 4300, click the Reports link 4304 (this causes the Reports page 4700 to be displayed); (2) from a Report Group dropdown 4702 click the report group name (for example, Budgeting & Forecast); (3) from a Reports list box 4704, click an individual report name; and (4) click run button 4706. The selected report is then generated and displayed for review.

Sales Analysis (SA) Module 278

The Sales Analysis (SA) module 278 enables owners to review and analyze the sales data reported by partners. FIG. 6000 illustrates a home page for the SA module 278. The SA module 278 includes two sub-modules/tasks: reports and PivotTable. Thus, SA home page 6000 includes two links: reports link 6002 and PivotTable link 6004 for accessing the reports and PivotTable tasks, respectively.

PivotTable Task: The PivotTable task allows an owner to access a Sales Analysis data 257. The sales analysis cube is an OLAP database, which arranges sales data according to multiple dimensions that correspond to different dimensional aspects of an owner's business, such as time, dollar amounts, products, geographical regions, and sales channels. The OLAP database is populated with data from the Sales Reporting module 274. Once the OLAP database is populated with information, that information can be displayed and navigated in a PivotTable, which is created though the PivotTable task.

A PivotTable is a multidimensional data structure that lets one quickly switch to different views of data. This ability to show “sliced” data lets one analyze information in small chunks. The PivotTable lets one analyze the data online; one can organize it virtually any way they want, look for broad information or details, and create summaries and reports from within your browser. With the PivotTable, one can view the sales database 257 in a variety of formats. One can find the data he or she needs to answer specific questions like which partners exceeded revenue goals and which individual products were more successful. A major advantage of using the PivotTable is that the information is already computed and available, and one can quickly get the answers by simply rearranging (or “pivoting”) the fields.

Selecting PivotTable link 6004 causes a sales analysis cube (not shown) to be displayed. With the built-in functionality of the sales analysis cube, the data in the cube can be “sliced,” or analyzed, across any one of the dimensions for a unique view.

Reports Task: The reports task is available only to owners. Owners use the SA reports task to select, generate, and display SA reports. A SA report is a pre-defined report providing sales related information. An owner can generate a selected report in any of three presentation formats: HTML, ActiveX, or Java.

To generate a SA report the following steps are performed: (1) from the SA home page 6000, select the reports link 6002 (this causes the reports page 4700 to be displayed); (2) from the Report Group dropdown 4702 click the report group name (for example, Sales Reports); (3) from a Reports list box 4704, click an individual report name; and (4) click run button 4706. The selected report is then generated and displayed for review.

Digital Style Guide (DSG) Module 279

Owners and partners use the Digital Style Guide (DSG) module 279 to trade property style assets (i.e., digital images) and related information via a secure network connection. This module facilitates the management and control of assets such as trademarks, logos, fonts, dimensions, color schemes, distribution, packaging, store display, and related information pertaining to brand owner property.

The DSG module 279 eliminates the cost, delays, and errors associated with traditional paper, and CD-ROM style guide distribution methods. The DSG module 279 is available 24-7. Owners use the DSG module 279 to create, and maintain a central, electronic data repository of property style assets. The category and asset structures are customized based on an owner's unique product offerings. Partners with the proper authorization can use the DSG module 279 to browse thumbnails of style guide assets or conduct a quick search to locate a specific asset. The partner can display detailed asset information, open a full-size view of file attachments, and immediately download selected assets.

FIG. 48 illustrates a DSG home page 4800. DSG home page 4800 includes links 4802-4812 for accessing the following sub-modules/tasks within the DSG module 279: upload, search, delete, browse, tools, and reports.

Upload task: The upload task is available only to owners. Owners use the upload task to add a new asset, such as an image, or document, to a selected online digital style guide. When upload is complete, the new asset is automatically added to the selected style guide, and is immediately available for download to all authorized partners via the browse and search tasks, which are described further below.

To access to the upload sub-module, the owner selects the upload link 4802. This causes an upload page 4900 to be displayed. To upload an asset, the owner first enters information into the upload page 4900. Specifically, the owner must select a style guide. This is done using the style guide title pull-down list 4902. The owner must also enter the following information: at title for the asset, the type of file that is being uploaded (e.g., tiff, jpeg, ascii, etc.), and a view/pose. The title of the asset is entered into text box 4904, the file type is entered into text box 4906, and the view pose is entered into text box 4908. Optionally, the owner may also enter a description of the asset, a resolution (provided the asset is an image file), a digital watermark, a watermark note, key words, and comments.

After the owner enters in the required information, the owner enters into text box 4920 the file name of the document or image associated with the asset that is being uploaded. If an image file is being uploaded, the owner has the option of specifying a location of a pre-existing thumbnail file of the image in text box 4930.

The last step in the upload process is to select either the “Save and Add Another” button 4950 or the “Save and Review” button 4952 The Save and Review button 4952 is used to upload a single asset or when there is a need to review each new upload prior to committing. Upon clicking the Save and Review command button 4952 a Review page 5000 is displayed. The Review page 5000 allows the owner to review the information he or she entered into the upload page 4900 before committing to the upload. If after reviewing the information entered into the upload page 4900 the owner is satisfied with the information that was entered into the upload page 4900, the owner selects the “Ok” button 5004, otherwise the owner selects the edit button 5002. Selecting Ok button 5004 causes the asset and the information entered by the owner to be uploaded to the server application 145. Selecting edit button 5004 causes an edit page 5100 to be displayed. With the edit page 5100, the owner can change the information that he or she entered using the upload page 4900. When the owner is satisfied that he or she has entered the correct information, the owner selects the save button 5102. Selecting save button 5102 causes the asset and the associated information to be uploaded to the server application 145.

The Save and Add Another button 4950 is selected when the owner needs to upload more than one asset. Selecting button 4950 causes the asset and the associated information to be uploaded to the server application 145. Thus, the asset uploads in single step by eliminating the review page 5000. When the Upload page 4900 redisplays, all fields, except for the asset title and filename, default to entries for the last asset. The owner continues to use the Save and Add Another command button to add new assets. When all assets have been uploaded, the owner clicks Done button 4951 to exit the upload sub-module.

Browse Thumbnails Task: Partners use the browse thumbnails task to display thumbnails of assets from every digital style guide they are authorized to view. Selecting the browse thumbnails link 4808 causes the browse thumbnails page 5200 to be displayed. The page 5200 displays thumbnails in reverse chronological order, in sequence by the date/time they were added to the Digital Style Guide via the upload task.

Each asset thumbnail has a download checkbox 5202 located beneath the thumbnail. To select an asset to download, the partner checks the checkbox associated with the asset. If a partner want more details about an asset, he or she can click the More Info icon 5204 located beneath the thumbnail for the asset. This causes a view asset page 5300 to be displayed. This page displays the information that the owner entered when he or she uploaded the asset. If the partners wants to view a full-size display of a thumbnail, the partner can click on the thumbnail itself or the filename located below the thumbnail. This causes the full-size image associated with the thumbnail to be displayed in a separate window so the partner can check out the details of the image. When the partner is finished browsing and wants to download the assets that he or she has selected, the partner clicks the Download Digital Assets button 5206. All the selected assets are downloaded to a location specified by the partner.

The Search Task: The search task is used to quickly locate an asset without browsing through thumbnails. Upon selecting the search link 4804 from the DSG home page 4800, a search page 5400 is displayed. This page allows the searcher to enter his or her search criteria. After the search criteria is entered into the page 5400, the search button 5402 is activated. The Display Results radio buttons (thumbnails 5404 and list view 5406) determine how the results of the search will be displayed. If the thumbnails option 5404 is selected, then after selecting the search button 5402 a thumbnail page 5500 is displayed.

Thumbnail page 5500 displays, in thumbnail form, the assets the matched the search criteria. If the list view option 5406 is selected, then after selecting the search button 5402 a list view page 5600 is displayed. List view page 5600 displays, in table form, the assets the matched the search criteria. From either thumbnail page 5500 or list view page 5600, the user can download on or more assets by selecting the assets and clicking the download button 5502/5602.

Delete Task: The Delete task is available only to owners (it is not available to partners). The DSG delete task is used to remove an asset from a specific style guide.

From the DSG home page 4800 the owner selects the delete link 4806. This causes a delete page 5700 to be displayed. The delete page 5700 is similar to the search page 5400. However, delete page 5700 search results are returned in table format only.

The owner enters his or her search criteria into the delete page 5700 by entering a value in one or more of the following fields: Style Guide Title, Digital Style Guide nodes/levels, View/Pose, Description, File Type, Resolution, Digital Watermark, Watermark Note, Key Words, Comments. The owner then clicks the search command button 5702, displayed at the bottom of the page 5700, to launch the search. The results of the search are displayed in a delete search results page 5800. To delete one or more assets from the search results page 5800, the owner selects the asset(s) by clicking on the checkbox 5804 associated with the asset(s) and then clicks the delete button 5804.

Tools Task: The tools task provides partners with access to third-party tools needed to view asset files. To access the tools task, a partner selects the tools link 4810 from the DSG home page 4800. This causes a tools page 5900 to be displayed. To make it easy to download the tools a partner may need, the tools home page 5900 provides hypertext links 5902 to third-party vendor web sites.

Reports Task: The reports task is available only to BRMS owners. Owners use the reports task to select, generate, and display DSG reports. A DSG report is a pre-defined report providing information regarding one or more Digital Style Guides. An owner can generate a selected report in any of three presentation formats: HTML, ActiveX, or Java.

To generate a DSG report, the owner must perform the following steps: (1) from the DSG home page 4800, select the Reports link 4812 (this causes the reports page 4700 to be displayed); (2) from the Report Group dropdown 4702, click the report group name (for example, DSG); (3) from the Reports list box 4704, click an individual report name; and (4) click run button 4706. The selected report is then generated and displayed for review.

As an additional feature, a Digital Style Guide (DSG) Shopping Cart module can be added to the system. The DSG Shopping Cart module (“shopping cart”) adds secure electronic commerce (“e-commerce”) functionality to the DSG by providing a mechanism for brand owners to sell assets. The DSG Shopping cart transforms the a DSG into an online store. A feature of the Shopping Cart is that it allows owners to specify which clients are authorized to purchase assets and which assets will be for sale.

Brand owner partners use shopping cart features in the Browse Thumbnails task to add selected items to a “shopping cart.” Cart selections are stored in database system 250 so that clients can review selections before placing orders. Order “check out” involves entering shipping, and payment information, based on requirements specified by the BRMS owner during system configuration. Once a partner receives order confirmation, he or she may seamlessly resume DSG browsing.

The Shopping Cart provides owners with easy-to-use administrative tools that are accessed from the Upload and Search tasks. Owners retain full control over the management of Shopping Cart item availability and pricing. An Owner can independently set up, modify, and remove assets from the online store. A Media Types Administration page 6100 (see FIG. 61) enables an owner to define and maintain a global table of all available media types (for example, CD, film, and tape) and set a default price for each type. An owner can indicate which media types are available for sale for a particular asset. A unique sale price (if different from a default) may also be entered for each media type per asset.

Owners with the proper security keys can access the Media Types page 6100 by clicking a Media Types command button 6202 on a Shopping Cart Administration page 6200 (see FIG. 62). The Media Types page 6100 is used to add media types to a media types list and to associate a default price with each defined media type. Media Types page 6100 is also used to edit and/or delete existing media type information. To add a media type to the media type list and to associate a default price with the media type, the owner enters the media type (e.g., CD, 8track, etc.) into the media type input box 6102, enters the default price into the default price input box 6104, and then selects the Add Media Type button 6106.

To edit or delete a media type, the owner would select the Show Media Types Table button 6102. FIG. 63 illustrates an exemplary Media Types Table 6300. To change the default price associated with a particular media type, the owner simply changes the price in the default price column 6304 and then selects an Update button (not shown). To delete a particular media type, the owner simply selects the checkbox in the delete column 6306 that is associated with the particular asset and then selects the Update button.

The complete list of media types that is created by the owner is displayed on the Shopping Cart Administration page 6200 under each asset, as is shown in FIG. 64, which illustrates the asset portion of page 6200.

Owners use the Available checkboxes 6402 to indicate which media types are available for sale for each asset. For example, for a particular asset, it is possible that the only media type that is available for sale is CD. For each asset media type, custom selling prices can also be entered into the Custom Price column 6404 to override the media type default pricing.

Partners with the appropriate authorization use the Browse Thumbnails task to display thumbnails of assets that they are authorized to view and to select assets for purchase. When a partner has the appropriate shopping cart security key, the Shopping Cart command buttons 6502 and 6504 display in the lower right corner of the Browse Thumbnails page 6500 (see FIG. 65). If an asset is available to be purchased, then a check box, such as check box 6506, is displayed beneath the thumbnail image of the asset. To purchase one or more assets, a partner selects the checkbox associated with each asset he or she desires to purchase, then selects the Add Selected To Cart button 6502, and then selects the View Cart button 6504. Selecting the View Cart button 6504 causes the View Cart page 6600 to be displayed (see FIG. 6600). Options on this page allow a partner to change selected order quantities and media types, as well as remove items from the “shopping cart.” To submit the order, the partner selects the Send Order (Normal) button 6602. Upon selecting the Send Order (Normal) button 6602, a Checkout page 6700 is displayed. To check out, the partner selects the Send Order Now button 6702. But it should be noted that if the partner does not have a profile established, the partner will need to enter his or her customer information into the Checkout page 6700. When the order is successfully submitted, a Billing page 6800 is displayed. If the information displayed on the Billing page 6800 is correct, the partner selects the Confirm Order button 6802, otherwise the partner selects the Back button (not shown) of the browser. After the order is successfully process, an Order Confirmation page 6900 displays and lists an order confirmation number.

While various embodiments of the present invention have been described above, it should be understood that they have been presented by way of example, and not limitation. It will be understood by those skilled in the art that various changes in form and detail may be made therein without departing from the spirit and scope of the invention as defined by the following claims. Thus the breadth and scope of the present invention should not be limited by any of the above-described exemplary embodiments, but should be defined only in accordance with the following claims and their equivalents.

What is claimed is:

1. A management system that enables a brand owner (“owner”) and its partners to work faster and more cohesively by streamlining business processes and information flows, comprising:
a central administration module for enabling the owner to set up and maintain the management system;
a sales reporting module for enabling the partner to submit sales data to the owner and for enabling both the owner and the partner to create and edit sales accounts;
a budgeting and forecast module for providing the owner with a collaborative, online forum for creating and monitoring royalty budgets and forecasts;
a sales analysis module for enabling the owner to review and analyze the sales data submitted by the partner;
an approvals module for providing a means for the partner to submit items for approval by the owner and for providing the owner with a means for reviewing submissions and a means for providing feedback to the partner regarding the submission;
a contract management module for providing a means for creating, editing, and viewing contract term sheets, and also for generating and reviewing detailed reports on selected contracts; and
a digital style guide module for providing the owner and the partner with a means to trade property style assets and related information.
